(19) United States
(12) Patent Application Publication
(10) Pub. No.: US 2010/0191562 A1
(43) Pub. Date: Jul. 29, 2010

(54) INTERNAL MATERIAL ACQUISITION AND REPORTING CONTROL SYSTEM

(75) Inventors: George Edward McFarland, Jr., Sykesville, MD (US); Ricardo Luis Rivera, Palm City, FL (US); Christian Roehl, East Wakefield, NH (US)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/686,882

(22) Filed: Jan. 13, 2010

Related U.S. Application Data
(60) Provisional application No. 61/145,918, filed on Jan. 20, 2009.

(51) Int. Cl. G06Q 10/00; G06F 17/30

(52) U.S. Cl. 705/7; 705/28; 707/769; 707/E17.014; 707/802; 707/E17.044

(57) ABSTRACT

A supply-chain of an enterprise is monitored and managed using a system that acquires information from a plurality of supply-chain databases and generates reports based on the acquired information. In some examples, a plurality of common data fields for the plurality of databases are determined, data regarding one or more procurement items from each of the plurality of databases is acquired, wherein the data for each of the one or more procurement items comprises data corresponding to each of the common data fields, and one or more reports about the one or more procurement items are generated based on the requested data.

This application claims the benefit of U.S. Provisional Application No. 61/145,918 by Ricardo L. Rivera et al., entitled, “Internal Material Acquisition and Reporting Control System” and filed Jan. 20, 2009, the entire content of which is incorporated herein by reference.

### TECHNICAL FIELD

The disclosure is generally directed to a system and method for managing supply-chain logistics.

### BACKGROUND

An enterprise typically has a purchasing process or “supply-chain” to purchase goods. Management of the supply-chain can be useful to understand how money is being spent by the enterprise and the performance of the personnel executing the purchasing process (e.g., buyers). In some cases, the purchased goods are used to perform one or more contracts or other agreements between the enterprise and its customer(s), such as a repair contract that requires the purchase of several parts or a manufacturing contract that requires the purchase and assembly of components. In this case, the management of the supply-chain may affect the performance of the contract and consequent customer satisfaction, payment under the contract, and future contracts with the same customer.

### SUMMARY

In general, the disclosure is directed to systems and techniques for managing a supply-chain of an enterprise.

In one example, the disclosure is directed to a method for generating reports based on data from a plurality of databases, the method comprising determining a plurality of common data fields for the plurality of databases, receiving data from each of the plurality of databases regarding one or more procurement items, wherein the data for each of the one or more procurement items comprises data corresponding to each of the common data fields, and generating one or more reports about the one or more procurement items based on the requested data.

In another example, the disclosure is directed to a system comprising a user interface comprising a display; and one or more processors configured to determine a plurality of common data fields for a plurality of databases, receive data from each of the plurality of databases regarding one or more procurement items, wherein the data for each of the one or more procurement items comprises data corresponding to each of the common data fields, and generate one or more reports about the one or more procurement items based on the requested data, and present the one or more reports to a user via the display of the user interface.

In another aspect, the disclosure is directed to a computer-readable storage medium comprising instructions that cause a programmable processor to determine a plurality of common data fields for a plurality of databases, receive data from each of the plurality of databases regarding one or more procurement items, wherein the data for each of the one or more procurement items comprises data corresponding to each of the common data fields, and generate one or more reports about the one or more procurement items based on the requested data, and present the one or more reports to a user via the display of the user interface.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a flowchart of an example integrated supply-chain procurement process.

FIG. 2 is a schematic diagram of an example supply-chain management system.

FIG. 3 is a flowchart of an example method for generating reports regarding procurement items with the supply-chain management system.

FIG. 4 is a schematic diagram of an example computing device that may be used with the supply-chain management system.

FIG. 5 is a screen shot of an example user interface screen for the supply-chain management system.

FIG. 6 is a screen shot of an example query tool for a backlog reporting module (BRM) of the supply-chain management system.

FIG. 7 is an example purchase requisition (PR) backlog activity report graph for an enterprise created by an example BRM of the supply-chain management system.

FIGS. 8A-8D are example PR backlog activity report graphs for various sites within the enterprise created by an example BRM of the supply-chain management system.

FIG. 9 is an example PR backlog aging report graph for an enterprise created by an example BRM of the supply-chain management system.

FIGS. 10A-10D are example PR backlog aging report graphs for various sites within the enterprise created by an example BRM of the supply-chain management system.

FIG. 11 is an example PR on-time processing report graph for an enterprise created by an example BRM of the supply-chain management system.

FIG. 12 is an example purchase order (PO) on-time delivery performance report graph for an enterprise created by an example on-time delivery module (ODM) of the supply-chain management system.

FIGS. 13A-13D are example PO on-time delivery performance reports graphs for various sites within the enterprise created by an example ODM of the supply-chain management system.

FIG. 14 is an example PO delivery backlog aging report graph for an enterprise created by an example ODM of the supply-chain management system.

FIGS. 15A-15D are example PO delivery backlog aging report graphs for various sites within the enterprise created by an example ODM of the supply-chain management system.

FIGS. 16A-16E are example screen shots of a vendor performance module (VPM) of the supply-chain management system.

FIG. 17 is an example drill down report of vendor performance created by an example VPM of the supply-chain management system.

FIGS. 18A-18C are further example screen shots of a VPM of the supply-chain management system.

FIG. 19A is example screen shots of query tool for vendor on-time performance for a VPM of the supply-chain management system.

FIG. 19B is an example report of vendor-on time delivery performance created by a VPM of the supply-chain management system.

FIG. 20 is a conceptual diagram of an example visual workplace for displaying reports created by the supply-chain management system.

### DETAILED DESCRIPTION

In general, this disclosure is directed to systems and methods for monitoring, managing, and reporting data relating to purchasing systems within an integrated supply-chain process of at least one enterprise. In some cases, the internal material acquisition and reporting and control systems (IMARCS) and techniques described in this disclosure can be useful for monitoring, managing, and reporting data relating to purchasing systems within a common enterprise. The systems and methods described in this disclosure can be useful when managing the supply-chain processes of an enterprise across multiple buying sites that are each employing a number of purchasing personnel (also referred to as buyers). For example, as described in further detail below, the systems and methods described in this disclosure track personnel resources across multiple sites (e.g., geographically separated sites) within an enterprise (or across multiple enterprises working together) and provides data that informs the process for reallocating resources the contributions of the personnel across different sites of the enterprise. In addition, as described in further detail below, the systems and methods described in this disclosure are useful for tracking the performance of the supply-chain process and can help identify specific areas for improvement and specific metrics for quantifying improvement.

The systems are generally referred to in this disclosure as Internal Material Acquisition Reporting & Control System, or IMARCS, and may also be referred to as Honeywell IMARCSs (HI-MARCSs). In one example, IMARCS is an integrated structured query language (SQL) server database reporting tool. IMARCS may form the foundation of an enterprise's integrated supply-chain performance measurement system or may be used in conjunction with existing supply-chain management systems. The improved visibility and reporting capability IMARCS provides into the integrated supply-chain processes across multiple purchasing systems and across multiple sites allow an enterprise to identify process bottlenecks, reduce cycle times and improve the ability to meet the needs of both the enterprise and its customers compared to systems that require buyers (within the enterprise) to log on to multiple supply-chain databases to fulfill a backlog of purchase requisitions or manage a backlog of purchase orders or perform any other task related to fulfilling supply-chain management.

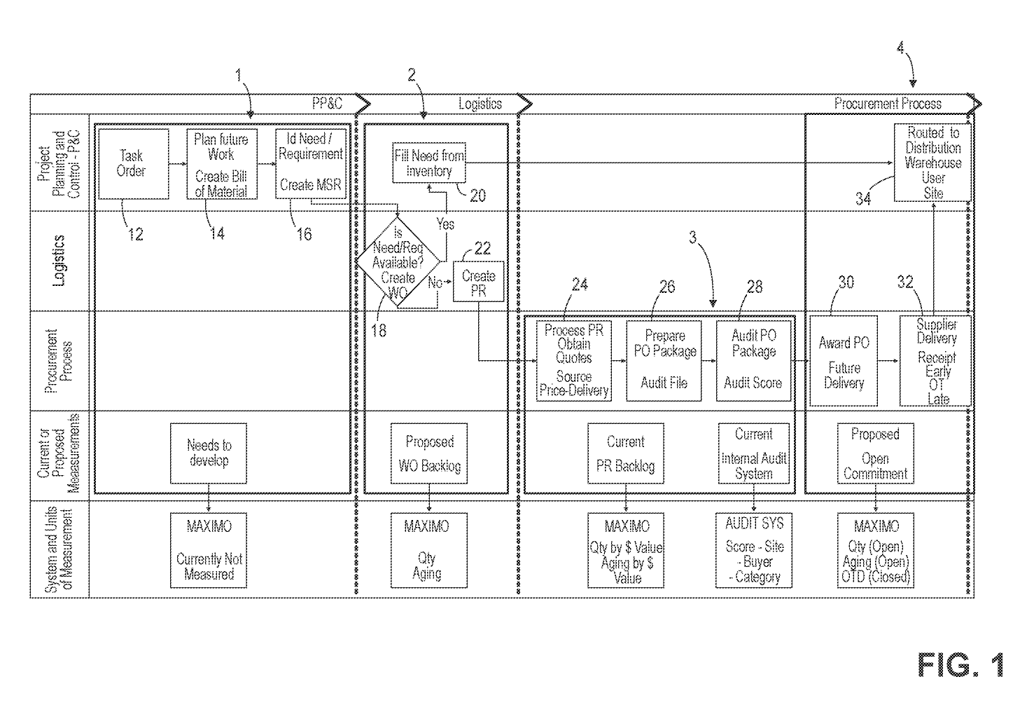

FIG. 1 illustrates a flowchart of an example integrated supply-chain procurement process 10. Procurement process 10 can take place within a single enterprise or between enterprises that are working in a joint effort to provide a service to a customer. In the examples described in this disclosure, however, for ease of description procurement process 10 is described as taking place within a single enterprise (e.g., which can include multiple divisions or a single division). The techniques described in this disclosure are applicable to an integrated supply-chain procurement process 10 that takes place within more than one enterprise. Procurement process 10 represents an example of the general process that may take place within an enterprise to purchase goods from a plurality of external vendors (e.g., vendors outside of the enterprise). An enterprise can purchase goods from multiple vendors because, e.g., different vendors supply different goods.

An enterprise may utilize a plurality of supply-chain databases, where each database stores information about the supply-chain of the enterprise. Types of information that can be stored include, but are not limited to, data relating to PRs entered by personnel within the enterprise (e.g., volume, frequency, type of goods requested, backlog to of PRs to be addressed, cost of the goods from specific PR or a plurality of PRs, and the like), data relating to POs generated by personnel in response to a PR (e.g., volume, frequency, backlog of POs to be fulfilled by a vendor, total cost of the goods on one or more POs, and the like), and data related to vendor performance (e.g., on-time delivery, volume of goods provided by a specific vendor, monetary value of business conducted with a vendor, with a specific vendor, past due deliveries, critical past due deliveries, and the like). The enterprise may use a plurality of supply-chain databases because, for example, different databases may be more relevant to purchasing goods from different vendors and/or the databases may have different functionality that is useful to the enterprise.

As described in further detail below, IMARCS allows a buyer (or another user) to access all at least some data common to a plurality of supply-chain databases through a single portal. IMARCS connects to the databases and retrieves the common data from the databases (e.g., by taking a snapshot of the common data in each database) to provide buyers and other enterprise employees with a quick and efficient measurement of supply-chain performance, and provide for visibility and reporting capabilities of the common data. Thus, IMARCS provides the ability to monitor and report open PR and PO backlogs across multiple vendors and multiple databases in order to evaluate the enterprise's management of its supply-chain.

In some examples, IMARCS is also configured to display the enterprise goals on reports so that a user can easily determine if supply-chain personnel are meeting the enterprise's goal. IMARCS can be useful for improving communication within an enterprise, as well as raising awareness and building confidence that the enterprise's supply-chain can meet customer need dates because results (e.g., supply-chain metrics) can be ascertained relatively quickly, despite the use of multiple databases to manage the supply-chain process. In some cases, the results can be communicated regularly to buyers and reported and posted regularly. Buyers and managers of the enterprise can utilize IMARCS to monitor the workload of buying sites or buyers and prioritize backlog activity on a regular basis. In addition, buyers are aware of and can monitor status and obtain feedback on a regular basis. Moreover, IMARCS helps an enterprise prioritize and track urgent or expedited requirements.

Integrated supply-chain procurement process 10 includes four stages 1, 2, 3, 4. In the first stage 1, a material service request (MSR) and a consequent work order (WO) are generated. In the second stage 2, a purchase requisition (PR) is generated to request the materials required for the work order. Then, in the third stage 3, the PR is approved and a purchase order (PO) is generated to get the requested materials from a supplier, also referred to as a vendor. Finally in the fourth stage 4, the supplier delivers the requested materials.

In the first stage 1, a work task is identified by an enterprise employee or customer, such as a repair order or a manufacturing order from a customer (12, referred to as a “Task Order” in FIG. 1). Next, the work needed to fulfill the task is planned and any needed materials are determined (e.g., by the employee, customer, or automatically by a computing device), also referred to as creating a bill of materials (14). Finally, a material service request (MSR) is created and a consequent work order (WO) is entered (16). The first stage is typically performed by an enterprise employee who works directly with the enterprise's customer. For example, the enterprise's customer may request that the enterprise perform maintenance on the customer's equipment at the customer's facility. An enterprise employee, referred to in this disclosure as a “requestor,” may determine what steps need to be taken and what materials, such as parts, equipment, or other materials, are needed to repair the equipment. The requestor may then create the MSR for the parts, equipment, and other materials needed. The requestor may also create a WO for the task. Once the MSR and WO are created, they are passed onto the second stage 2.

In a second stage 2, it is first determined if the materials required in the MSR are available in the enterprise's inventory (18). This determination may be made by an enterprise employee, such as the requestor described above or enterprise employees who oversee the procurement process, referred to in this disclosure as “buyers,” or the determination may be made automatically by a computer system. If the materials are available in inventory, they are passed on directly to a fourth stage 4, described below, by filling the need from the enterprise's inventory (20) and then routing the materials to the work site where the materials are needed (34). If the materials needed are not available in inventory, a purchase requisition (PR) is generated (22) to request the materials required for the WO. In a third stage 3, the PR is reviewed and approved by an enterprise employee, also referred to as PR processing, and if desired quotes are obtained from suppliers (24). Once a particular supplier (also referred to in this disclosure as a vendor) is selected, a purchase order (PO) is generated (26) to get the requested materials from the supplier. The steps of the second and third stages 2, 3 may be performed by buyers within the enterprise.

If the enterprise is relatively large and/or geographically dispersed (e.g., not within a single facility), groups of buyers may be situated at specific locations within the enterprise, referred to in this disclosure as “buyer sites” or “sites.” Each buyer and buyer site may be assigned to the procurement associated with a particular division within the enterprise, with one or more particular customers of the enterprise, or with one or more particular suppliers used by the enterprise. In the example described above, after the requestor creates the MSR, it may be routed to one or more buyers who determine if any of the materials requested in the MSR are available in the enterprise's inventory. In other examples, a computer system may automatically cross check the materials requested in the MSR with materials available in inventory and fulfill those materials that are in inventory automatically so that the buyers need only deal with those materials not already available in inventory.

When the materials are not available in inventory, the buyer creates a PR for the remaining materials. In other examples, the PR may be created automatically by a computer system. Once the PR is created, it may be is processed by a buyer or another enterprise employee, and the buyer may then obtain quotes from supplier for the particular materials (24). Alternatively, the enterprise may have predetermined suppliers for each particular material or material type such that the selection of suppliers may be made automatically. Next, the buyer may create one or more POs (26) for the materials in the PR. The method may also include reviewing or auditing process to review POs (28).

In the fourth stage 4, the PO is awarded and submitted to a supplier (30) (also referred to as a vendor in this disclosure), and the supplier fulfills the PO, such as by manufacturing the materials or obtaining the parts from its own vendors or suppliers, and finally delivers the materials to the enterprise (32). Delivery of the materials may be directly to the work site where the materials are needed, also referred to as a user site. Examples of user sites include, but are not limited to, a factory in which components are assembled into a final product or a site in which the newly shipped parts are used to build or repair equipment. Alternatively, the supplier may deliver the materials to a centralized facility of the enterprise, such as a warehouse, wherein the enterprise then routes the materials to the work site (34). As with the second stage 2 and third stage 3, the steps of the fourth stage 4 may be performed by buyers within the enterprise. In the examples discussed above, once a PO is created and reviewed/audited, it is awarded to a particular supplier (30) who fulfills it (32).

In order to manage the procurement process, buyer(s) need to monitor POs to determine which are due soon and which are overdue, such as by setting up reminders for the buyer at a specified number of days before the PO due date or providing a listing of all POs that are overdue or that are due within a specified number of days. This allows the buyer to ensure prompt fulfillment of the POs, such as by sending reminders to the suppliers at certain times (e.g., a week before a PO is due or immediately after a PO becomes overdue). Buyer and supplier management can be useful for managing the supply-chain to increase the number of on-time deliveries of materials to user sites, which can help improve the efficiency with which the enterprise operates. IMARCS provides the ability to monitor and report an open PR backlog and an open PO backlog, including the quantity and aging of open PR backlog, PR processing cycle times, open PO backlog, PO processing cycle times, and the ability to monitor and prioritize buyer performance

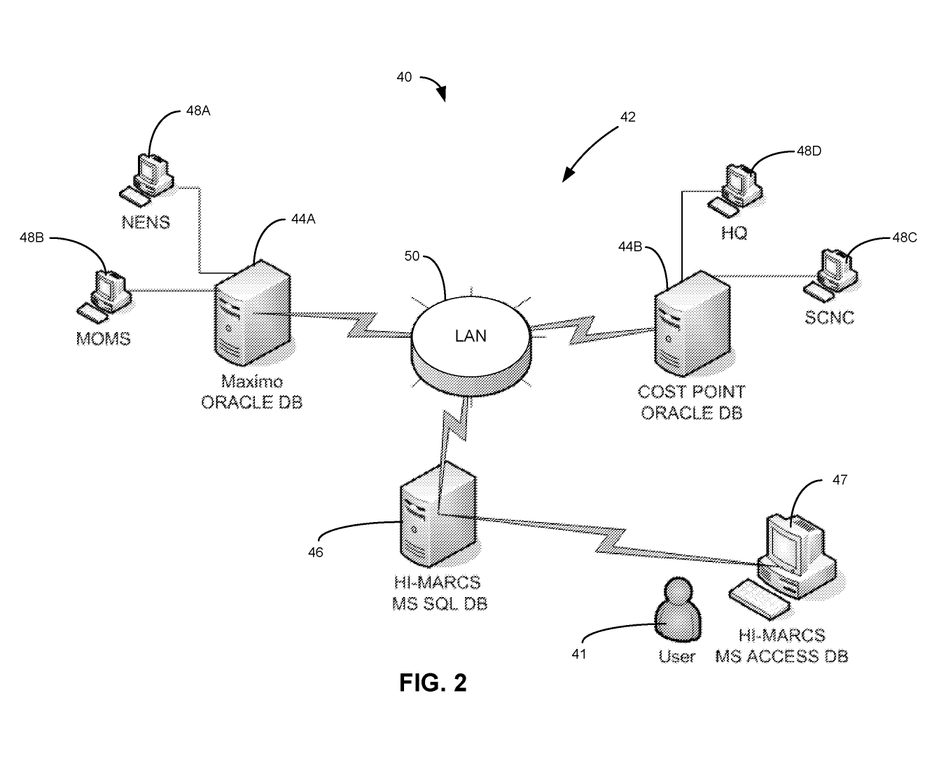

FIG. 2 shows an example configuration of a system 40 incorporating IMARCS. IMARCS system 40 may be used to coordinate a heterogeneous network 42 of supply-chain databases (DBs) 44 shown in FIG. 2. Example databases 44 include, but are not limited to, an Oracle database 44A (Oracle Corporation of Redwood City, Calif.) running Maximo Asset Management software (International Business Machines of Armonk, N.Y.) (hereinafter referred to as Maximo Oracle DB 44A) and an Oracle database 44B running Costpoint accounting software (Deltek, Inc. of Herndon, Va.) (hereinafter referred to as Costpoint Oracle DB 44B). These databases are merely provided as examples, and different databases can also be used with the IMARCS system described in this disclosure. IMARCS system 40 may also include a common IMARCS DB 46 that is used for the storage of common data from supply-chain databases 44 and for access to the common data for users of IMARCS system 40. Each supply-chain DB 44 may be executed by a computing device and may utilize one or more database software systems, such as but not limited to, an Oracle database software system, a Microsoft structured query language (MS SQL) database software system (Microsoft Corporation of Redmond, Wash.), or an SAP enterprise resource planning (SAP ERP) database software system (SAP Aktiengesellschaft of Walldorf, Germany).

Each supply-chain DB 44 may support one or more buyer locations or “sites” within an enterprise, such as a NENS buying site 48A and a MOMS buying site 48B, SCNC buying site 48C, and a headquarters (HQ) buying site 48D. In the example shown in FIG. 2, NENS buying site 48A and a MOMS buying site 48B can be supported by a first database, SCNC buying site 48C can be supported by a second type of database, and HQ buying site can be supported by a third type of database, where the first, second, and third types of databases are different. However, in some examples, at least two of the buying sites 48A-48D can utilize the same type of database.

The heterogeneous network 42 of supply-chain DBs 44 may be connected by a public or private network 50, such as a local area network (LAN) as shown in FIG. 2. In other examples, network 50 may be any other type of public or private data network and may be wired or wireless. Network 50 can be any network hardware that is capable of transmitting the data regarding MSRs, WOs, PRs, or POs. Examples of networks that could be used with system 40 include hard-wired systems in which supply-chain DBs 44, IMARCS DB 46, and buying sites 48 are directly connected by cables or wires capable of transmitting supply-chain data or by wireless connection. Examples of hard wired systems include wired computer networking methods including coaxial cables, digital subscriber line (DSL), Ethernet, fiber optics, and power line communication. Wireless systems can use radio, microwave, radiofrequency, or infrared technologies for communications. Examples of wireless methods that can be used in network 20 include a network utilizing an air interface, wireless local area network (WLAN) devices corresponding to IEEE 802.11 standards (commonly referred to as Wi-Fi), mobile telecommunications protocols including global system for mobile communications (GSM), code division multiple access (CDMA), Universal Mobile Telecommunications System (UMTS), Evolution-Data Optimized systems (EV-DO), ZigBee, Worldwide Interoperability for Microwave Access (WiMAX), and satellite communications.

Network 50 may also allow for secure communication within heterogeneous DB network 42, such as through the use of communication-security techniques such as, but not limited to, secure sockets layer (SSL), transport layer security (TLS), secure shell (SSH), virtual private network (VPN), IP security (IPSec), trusted computer system evaluation criteria (TCSEC) (also known as “Orange Book” techniques), ISO/IEC 15443, 15408, or 17799 techniques, public/private key techniques such as an Rivest, Shamir and Adleman (RSA) algorithm, or any other cryptographic algorithms. A user 41 of IMARCS system 40 may access the data or reports created by IMARCS system 40 through a computing device 47, which may be connected to any of the DBs 44 or 46, such as the IMARCS DB 46 shown in FIG. 2, or to the network 50, to allow for communication with all DBs within heterogeneous network 42 of DBs.

IMARCS system 40 may be configured to generate reports, data tables, and report formats in any form that may be compatible with one or more types of enterprise data resources, such as commercial software packages that may be used by the enterprise, including Costpoint provided by Deltek, Inc., asset management software such as Maximo from International Business Machines Corp., display and reporting software such as Microsoft Excel, statistics software such as Minitab (Minitab Inc. of State College, Pa.) which may import data into spreadsheets, graphs, and other spreadsheet resources. Further, existing networking software and hardware may be used to transport data to and from IMARCS system 40. However, other software and/or hardware resources, including custom software may be used instead or as well.

Large enterprises often maintain multiple supply-chain DBs 44 to support and execute the hundreds or thousands of PRs and POs that are created and fulfilled every week. Moreover, fulfilling large contracts or contracts for different purposes requires purchasing from dozens, if not hundreds of different suppliers. Adding to this already difficult task of tracking and fulfilling purchase requisitions and purchase orders is the fact that the enterprise might need to use several different purchasing database systems for various reasons (e.g., because of customer requirements, supplier requirements, legacy use, etc.). A buyer who is attempting to fulfill her backlog of purchase requisitions or manage a backlog of purchase orders may be required to log onto each of the multiple databases to perform any task related to fulfilling supply-chain management, including creating a purchase requisition, determining the quantity of backlogged purchase requisitions that must be fulfilled, determining ages of various groups of purchase requisitions (e.g., how many were created in the last week, how many are one to four weeks old, how many are one to three months old, etc.), determining the cycle time of specific purchase requisitions or average cycle time of a particular group of purchase requisitions such as the purchase requisitions being fulfilled by a specific buying site or a specific buyer.

Similarly, because the data is spread out over numerous databases, evaluating supplier performance is also challenging, because there is no way to easily and quickly (e.g., in a time efficient manner) determine things like on-time delivery performance for PRs or POs for a particular buyer site, buyer, or supplier, or to track and expedite critical or past due deliveries. The use of multiple supply-chain DBs 44 running multiple types of database software systems makes it difficult for a buyer to effectively manage a backlog of MSRs, PRs, and/or POs because the buyer must check each of the DBs 44 and navigate various formats of data and databases to perform the relatively simply task of determining what MSRs, PRs, or POs have yet to be fulfilled.

The data that the buyer needs to acquire to manage the backlog is essentially the same in each supply-chain DB 44. This data, referred to in this disclosure as “common data” or “common data fields,” includes several data fields about procurement items in the supply-chain that are common to each supply-chain DB 44. Examples of common data or common data fields include, but are not limited to, buyer, vendor, buying site (e.g., within an enterprise), program, business segment of the enterprise, source system, a project identifier such as a project identification code, a work breakdown structure (WBS), a PR identifier such as a PR number, a PR created date, a PR approval date, a PR priority, a PO generation (“cut”) date, a PO identifier such as a PO number, a PO due date, a PO type (such as for a service or for physical goods), a PO value, a PO description line, a delivery date of goods, a date goods are received by the enterprise, a quantity of goods received by the enterprise, a quantity of good accepted by the enterprise, and a net unit cost of the goods. IMARCS system 40 allows a buyer (or another user) to access all the common data across all the supply-chain DBs 44 or a selected subset of the supply-chain DBs 44 through a single portal by connecting to the selected supply-chain DBs 44 and taking a snapshot of the common data in each DB 44 that provides buyers and other enterprise employees with a quick and efficient measurement of supply-chain performance, and provides for visibility and reporting capabilities of the common data. For example, by tracking PR creation dates, the IMARCS system 40 helps ensure that old PRs may be addressed prior to those newly received, if they have the same priority.

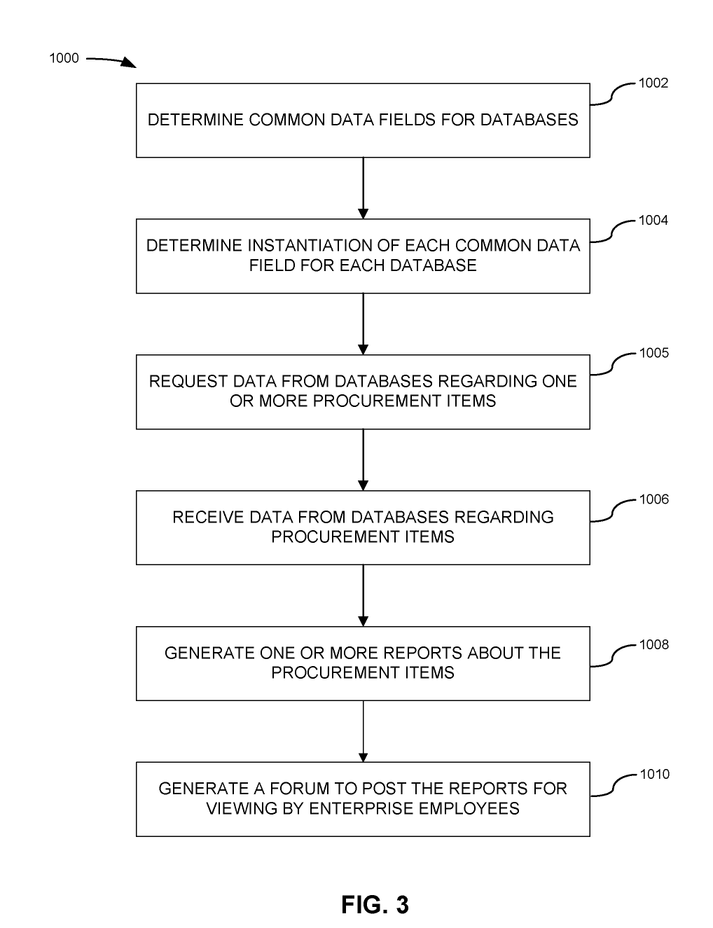

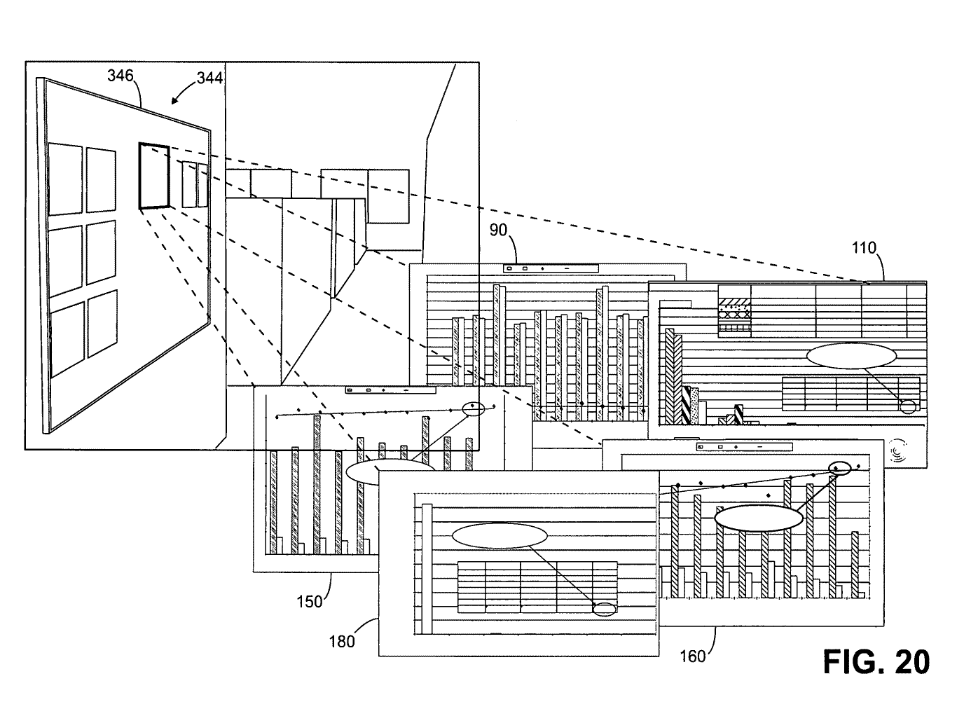

FIG. 3 is a flow diagram of an example technique IMARCS system 40 can implement to generate reports based on data from a plurality of databases 44. Each step of the example technique shown in FIG. 3 may be performed by one or more computing devices and/or databases within IMARCS system 40. In the example shown in FIG. 3, the technique includes determining a plurality of common data fields for the plurality of databases 44 (1002), determining instantiation of each of the plurality of common data fields for each of the plurality of databases (1004), receiving data from each of the plurality of databases regarding one or more procurement items (1006), wherein the data for each of the one or more procurement items comprises data corresponding to each of the common data fields, and generating one or more reports about the one or more procurement items based on the requested data (1008). The reception of data from the plurality of databases regarding the one or more procurement items (1006) may be prompted by a request, either by a user or through an automatic request by a computing device or system, to supply-chain DBs 44 for the data regarding the one or more procurement items (1005). In one example, IMARCS system 40 can be instructed to request data from the supply-chain DBs 44 immediately such as in response to an audit or upcoming financial deadline. Then, based on the common data, IMARCS system 40 can generate a variety of reports, including but not limited to, cycle times for each step of the integrated supply-chain process 10. The method of creating reports may further comprise generating a forum, such as a visual workplace 344 (FIG. 20) to post one or more of the generated reports for viewing by employees of an enterprise (1010).

In general, instantiation of each common data field includes capturing data relating to each of the common data fields from the selected supply-chain DB 44 at a particular point in time, such that the data acquired for each of the data fields is acquired at substantially the same time. However, data for different data fields can be acquired at different times in other examples. In some examples, determining instantiation of the common data fields (1004) may include acquiring data regarding each PO and PR from each supply-chain DB 44 as indicated in the common data fields at scheduled regular intervals, such as once a day at a set time, allowing buyers/managers to verify backlog conditions each workday. In one example, the common data fields are combined into IMARCS DB 44 to provide for central storage and retrieval of the common data by users of IMARCS system 40.

The received data regarding one or more procurement items received from the plurality of databases 44 (1006) may comprise one or more material service requests (MSRs), one or more work orders (WOs), one or more purchase requisitions (PRs), and one or more purchase orders (POs) for an enterprise. The reports generated (1008) may comprise one or more reports on purchase requisition backlog activity, one or more reports on purchase requisition backlog aging, one or more reports on purchase requisition on-time processing, one or more reports comprise one or more reports on purchase order on-time delivery, such as one or more reports on the on-time delivery performance on a per vendor basis or a breakdown of the on-time delivery on a per purchase order basis, or one or more reports on purchase order backlog aging.

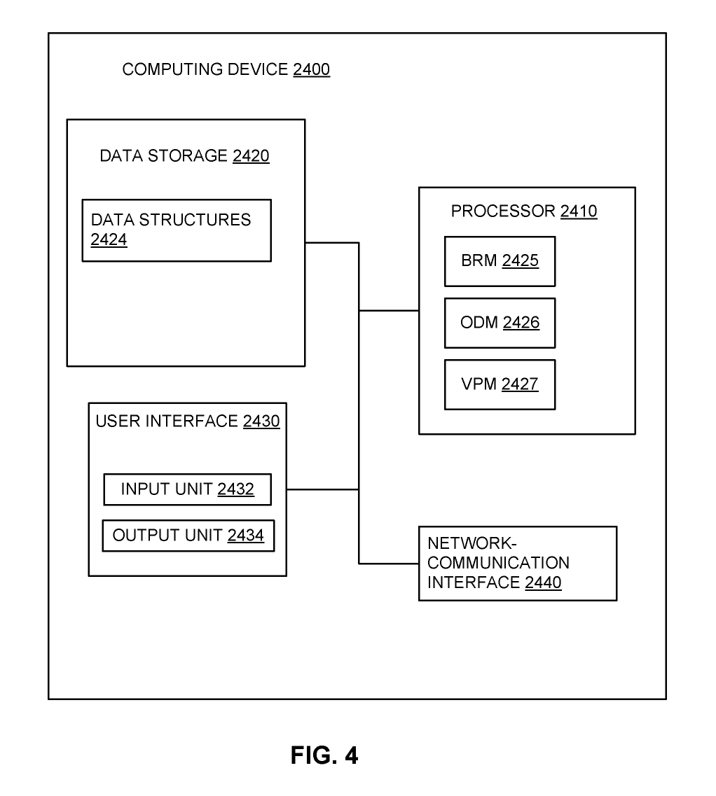

As described above with respect to FIG. 2, user 41 of IMARCS system 40 may access the data or reports generated by IMARCS system 40 through a computing device 47. FIG. 4 is a block diagram of an example computing device 2400 that may be used with IMARCS system 40, such as computing device 47 shown in FIG. 2. Example computing device 2400 includes processor 2410, data storage 2420, a user interface 2430, and network-communication interface 2440. Computing device 2400 may be, for example, a desktop computer, laptop or notebook computer, personal data assistant (PDA), mobile phone, embedded processor, or any similar device that is equipped with a processor capable of executing instructions that implement some or all of the functionality of the IMARCS system 40 described in this disclosure.

Processor 2410 can include one or more processors, such as one or more central processing units, computer processors, mobile processors, digital signal processors (DSPs), application-specific integrated circuits (ASICs), graphics processing units (GPUs), field programmable gate arrays (FPGAs), microprocessors, computer chips, integrated circuits, or any other equivalent integrated or discrete logic circuitry, as well as any combinations of such components, now known or later developed, and may execute instructions and process data. The term “processor” or “processing circuitry” may generally refer to any of the foregoing logic circuitry, alone or in combination with other logic circuitry, or any other equivalent circuitry. Processor 2410 may be incorporated in a computing device, such as computing device 47 in FIG. 2 or computing device 2400 in FIG. 4.

Data storage 2420 can comprise one or more storage devices. Data storage 2420 may include, for example, read-only memory (ROM), random access memory (RAM), non-volatile RAM (NVRAM), electrically erasable programmable ROM (EEPROM), removable-disk-drive memory, hard-disk memory, magnetic-tape memory, flash memory, and similar storage devices now known and later developed. The data storage 2420 comprises at least enough storage capacity to contain data structures 2424.

In one example, processor 2410 is part of a computing device 2400 such that processor 2410 is configured to perform the functions described above to enable the functionality of IMARCS system 40. For example, processor 2410 can be configured with hardware, firmware, software or any combination thereof that permits processor 2410 to perform these functions. Such hardware, software, or firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to processor 2410 and, more generally, IMARCS system 40, may be embodied as instructions on a computer-readable medium such as RAM, ROM, NVRAM, EEPROM, FLASH memory, magnetic data storage media, optical data storage media, or the like. In one example, the computer-readable medium may comprise data storage 2420, shown in FIG. 4, or it may be a separate computer-readable medium. Data storage 2420 may include instructions executable by the processor 2410 and any storage required, respectively, to support one or more aspects of the functionality described in this disclosure, including but not limited to the functionality of a backlog reporting module (BRM) 2425, an on-time delivery module (ODM) 2426, a vendor performance module (VPM) 2427, and a visual workplace 2428, described in more detail below.

In the example shown in FIG. 4, user interface 2430 includes input unit 2432 (also referred to as a user input mechanism or input device) and an output unit 2434. Input unit 2432 is configured to receive user input from a user of the computing device 2400. For example, input unit 2432 can include any one or more of a keyboard, a keypad, a touch screen, a computer mouse, a track ball, a joystick, stylus, and/or other similar devices, now known or later developed, capable of receiving user input from a user of the computing device 2400.

Output unit 2434 provides output to a user of the computing device 2400. For example, output unit 2434 can comprise a visible output device, such as one or more cathode ray tubes (CRT), liquid crystal displays (LCD), light emitting diodes (LEDs) displays, displays using digital light processing (DLP) technology, printers, light bulbs, and/or other similar devices, now known or later developed, capable of displaying graphical, textual, and/or numerical information to a user of computing device 2400. Output unit 2434 may alternately or additionally comprise one or more aural output devices, such as a speaker, speaker jack, audio output port, audio output device, earphones, and/or other similar devices, now known or later developed, capable of conveying sound and/or audible information to a user of computing device 2400.

Network-communication interface 2440 is configured to communicate with other devices e.g., to send and receive data over a wired-communication interface and/or a wireless-communication interface to transmit or receive the data over a network, such as network 50 shown and described with respect to FIG. 2. The wired-communication interface, if present, may comprise a wire, cable, fiber-optic link or similar physical connection to a data network, such as a wide area network (WAN), a local area network (LAN), one or more public data networks, such as the Internet, one or more private data networks, or any combination of such networks, such as network 50 shown in FIG. 2. The wireless-communication interface, if present, may utilize an air interface, such as a ZigBee, Wi-Fi, and/or WiMAX interface to a data network, such as a WAN, a LAN, one or more public data networks (e.g., the Internet), one or more private data networks, or any combination of public and private data networks. Network-communication interface 2440 may enable secure communications, perhaps by the use of communication-security techniques such as, but not limited to, Secure Sockets Layer (SSL), Transport Layer Security (TLS), Secure Shell (SSH), Virtual Private Network (VPN), IP Security (IPSec), Trusted Computer System Evaluation Criteria (TCSEC)/Orange Book techniques, ISO/IEC 15443, 15408 and/or 17799 techniques, public/private key techniques such as the RSA algorithm, and/or other cryptographic algorithms.

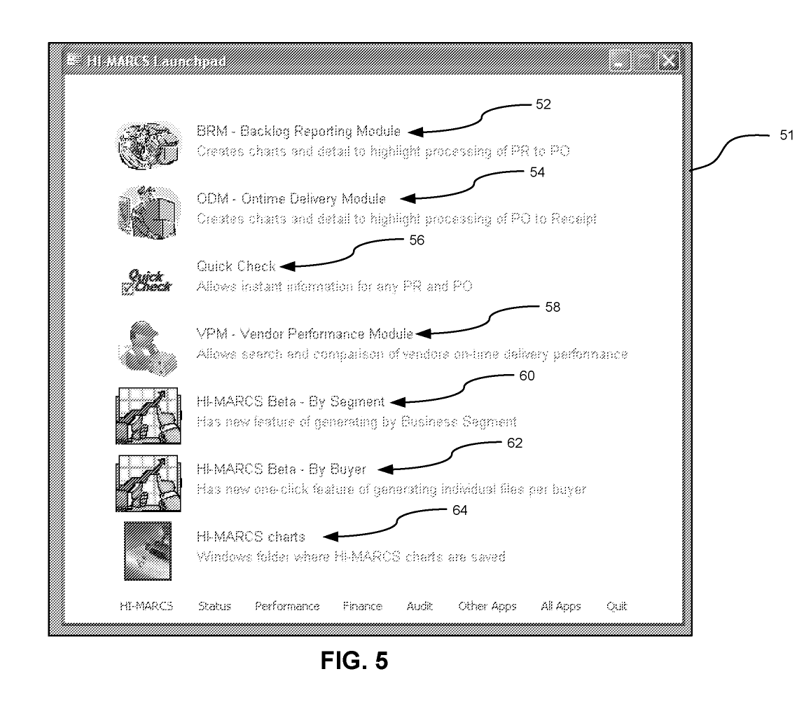

FIG. 5 shows an example user interface screen 51 presented by IMARCS system 40 on a display (e.g., such as a computer monitor) of output unit 2434 of computing device 2400. User 41 interacts with IMARCS system 40 (e.g., provided by computing system 2400) via the various user interface screens described in this disclosure, whether the user interface screen is merely a display that is configured for passive user interaction (e.g., passive observation by a user) or whether the user interface screen is configured for active user interaction (e.g., receipt of user input).

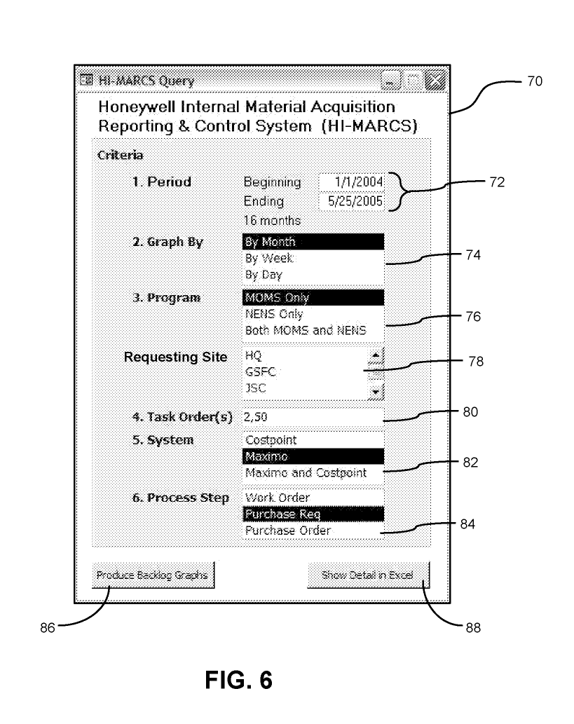

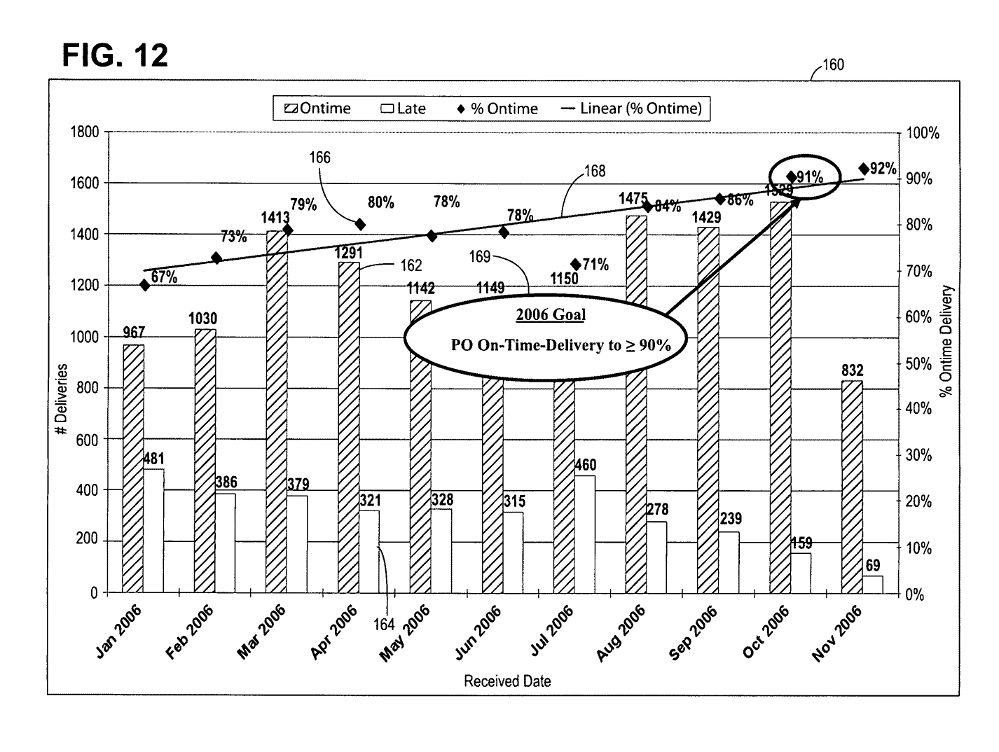

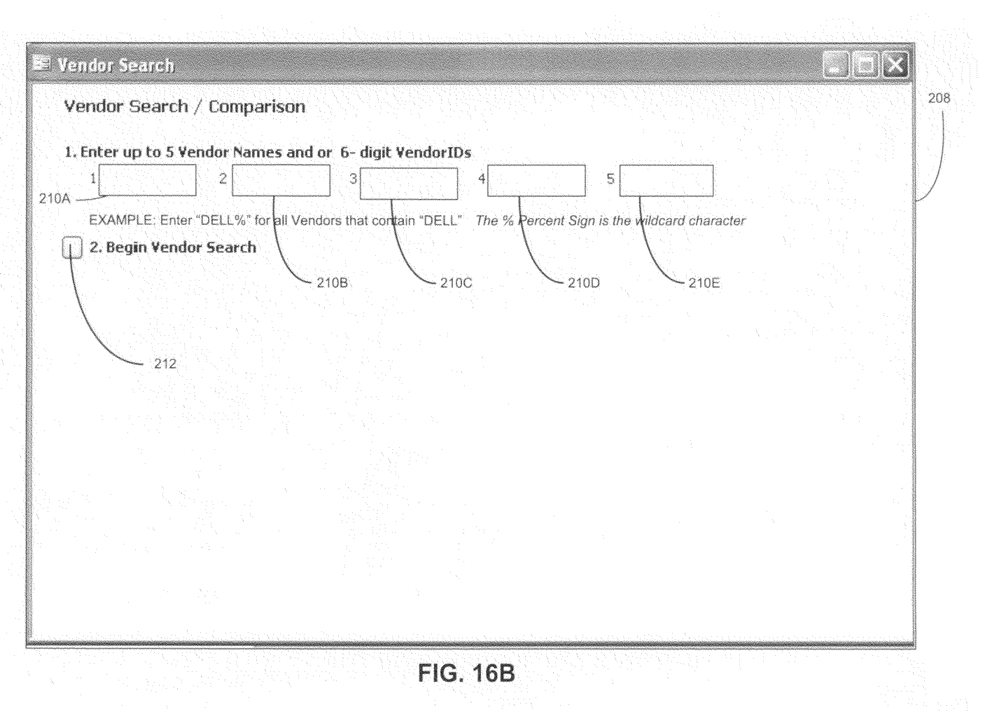

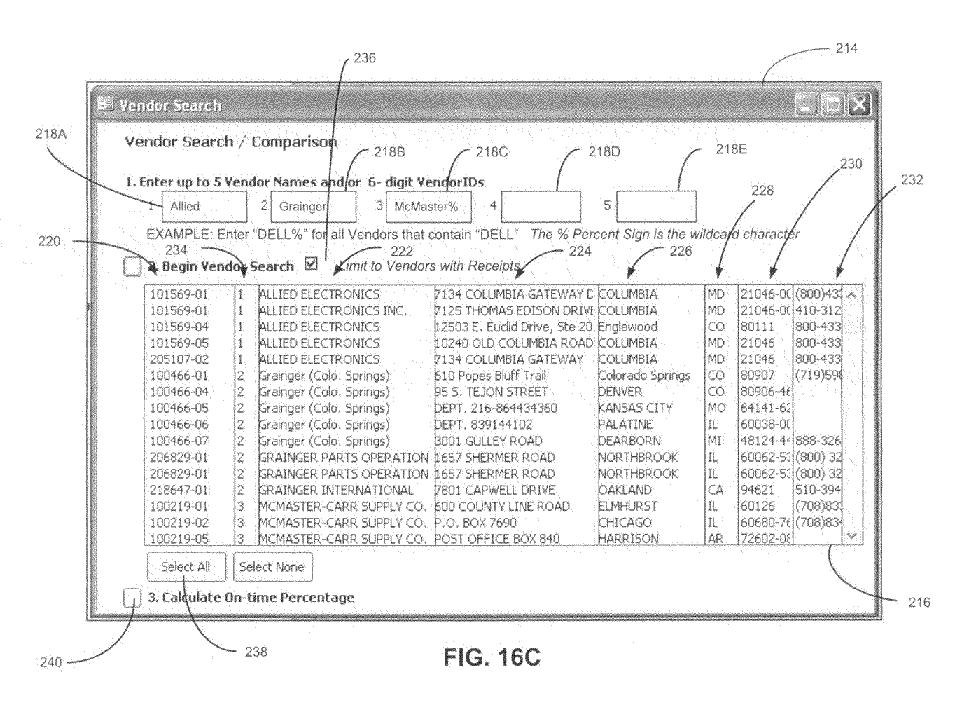

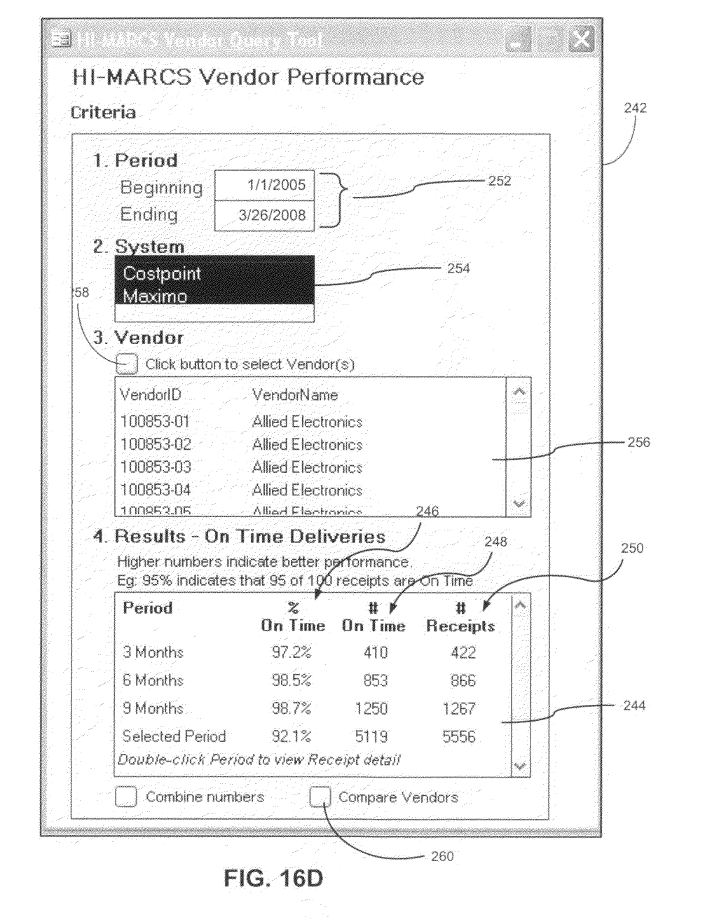

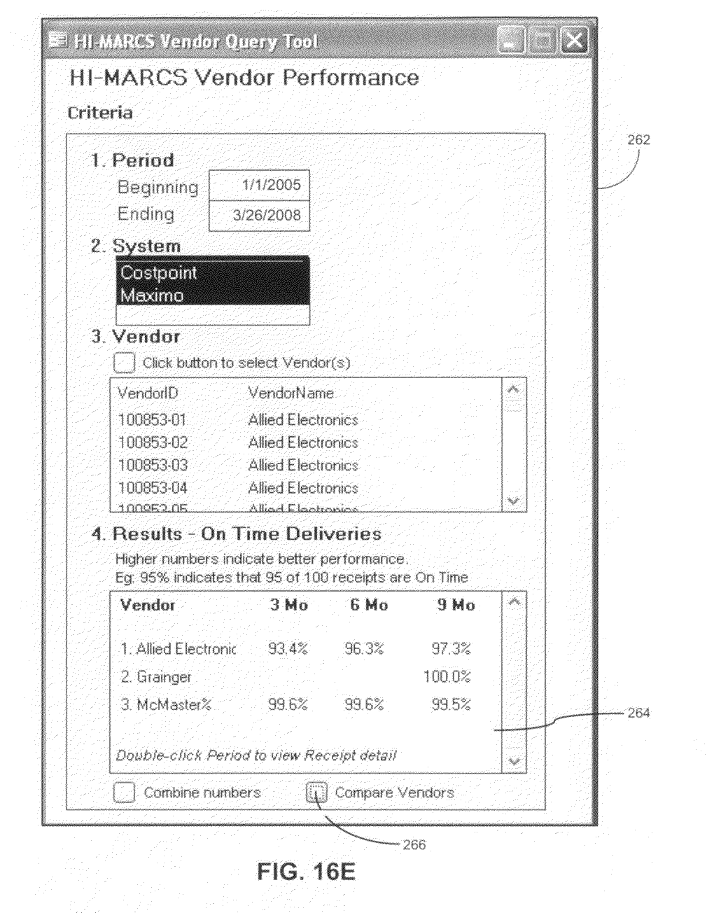

User interface screen 51 shown in FIG. 5 can be, for example, a screen that presents different functions of IMARCS system 40 for selection by user 41. User interface screen 51 may include links to the analysis and reporting modules described below, such as link 52 to backlog reporting module (BRM) 2425 (described below with respect to FIGS. 6-11), link 54 to on-time delivery module (ODM) 2426 (described below with respect to FIGS. 12-15), link 56 to a quick check module to check the status of a specific PR or PO, link 58 to a vendor performance module (VPM) 2427 (described below with respect to FIGS. 16-19), link 60 to reports on a per business segment basis, link 62 to reports on a per-buyer basis, and link 64 to other IMARCS reports and charts. Although not shown in FIG. 5, IMARCS system 40 may permit access to other tools and reports, such as a monthly funding report and/or auditing tools. Upon receiving user input via user input unit 2432 (FIG. 4) selecting of any one of links 52, 54, 56, 58, 60, 62, 64 presented by user interface screen 51, processor 2410 can present different user interfaces to user 41 that provide user 41 with access to the selected feature of IMARCS system 40.

FIGS. 6-11 show example user interface screens generated by BRM 2425 of IMARCS system 40 for tracking and analyzing buyer performance in creating and fulfilling PRs. In one example, BRM 2425 monitors open backlog and aging and/or cycle times of WOs, PRs, and POs, such as by monitoring and reporting on the time between WO creation and PR creation, PR creation and PO creation, and between PO creation and delivery of the requested materials. BRM 2425 may further provide for real time reporting, including reporting from both Costpoint and Maximo or any other type of supply-chain DB 44, custom and ad hoc reporting capabilities, reports by buying site (such as a report for a first buying site 48A or a second buying site 48B) and/or by program (such as a report for a specific contract, where the contract/program may include multiple projects or task orders necessitating different sets of MSRs, PRs, and POs), generation of trend data by site or program, and reporting of on-time delivery performance and past-due aging. In general, BRM 2425 is configured to generate reports based on data relating to buyer performance in creating and fulfilling PRs and in managing POs, such as, but not limited to, open backlogs, cycle times of WOs, PRs, and POs for a user-selected time range, past-due aging, on-time delivery performance, and the like. Reports generated by BRM 2425 may be displayed on output unit 2434 of computing device 2400, such as a computer monitor or printer, to be viewed by a user of IMARCS system 40.

In one example, shown in FIG. 6, BRM 2425 generates and presents query tool user interface screen 70, which allows user 41 to select the overall reporting period by entering a beginning and end date in fields 72. User 41 may also select the frequency of data points, for example on a monthly, weekly, or daily basis in field 74. Data may also be reported on a per-program basis by selecting one or more of the programs listed in field 76. Field 76 also allows a user to report on data from all programs, for example in FIG. 6 a user may select “Both MOMS and NENS” to pull data from both the MOMS program and the NENS program, which are the only programs in the example of FIG. 6. Data can also be selected for a particular buying site 48 by selecting the buying site 48 of interest in field 78. Procurement items may also be drilled down to a specific task order, such as a specific project portion of a contract that may comprise its own set of MSRs, PRs, and POs, in FIG. 6 by entering a task order number in field 80 (such as task order numbers 2 and 50 entered in FIG. 6).

User interface screen 70 includes feature that allow user 41 to select one or more data sources or “Systems” in field 82, such as by selecting one or more supply-chain DBs 44 or, as shown in FIG. 6, by type of supply-chain database (shown as Costpoint Maximo, or both). Reports may also be drilled down to each sub-step described above with respect to procurement stages 1 through 4 (FIG. 1) by selecting specific procurement items in field 84, such as the “Work Order” to view WOs, “Purchase Req” to view PRs, and “Purchase Order” to view POs. In one example, a specific task order need not be entered in field 80, but rather only the desired process steps may be selected in field 84 and the data corresponding to the selected process steps may be viewed for all task orders that meet the data requirements of fields 72, 76, 78, 82 and 84.

By selecting button 86 via input unit 2432, user 41 can interact with BRM 2425 of IMARCS system 40 to generate reports, e.g., for backlog tracking and aging management, based on the user input selecting options via fields 72, 74, 76, 78, 80, 82, and 84. The reports can be in the form of graphical displays, referred to in this disclosure as graphs, or textual displays. Graphs are primarily referred to in this disclosure. However, each of the modules of IMARCS system 40 can also generate reports that comprise primarily textual information. Upon receiving input via button 86, BRM 2425 (FIG. 4) can generate the relevant graphs using instructions stored by data storage 2420 (FIG. 4). In some examples, BRM 2425 (as well as the other modules described in this disclosure) automatically generates a predetermined number and type of reports upon receiving user input from user 41 via button 86 requesting the generation of reports. In other examples, BRM 2425 (as well as the other modules described in this disclosure) presents a user interface screen with which user 41 can select the type of reports to be generated by BRM 2425. In this way, user 41 can customize the types of reports generated and presented by IMARCS system 40.

BRM 2425 may also be configured to export the data to another program, such as to a spreadsheet software program (e.g., Microsoft Excel provided by Microsoft Corporation of Redmond, Wash.), to create spreadsheets based on the data, for example by having a user click a button 88 to prompt the exportation of the data to the software program.

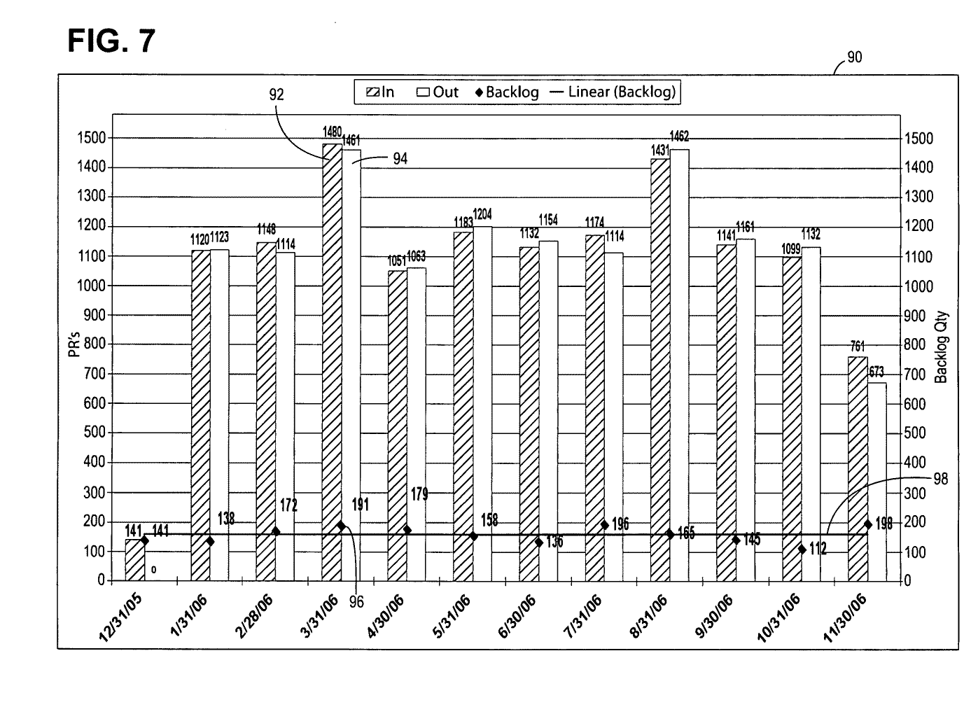

FIGS. 7-15 show example reports that may be created by BRM 2425 based on information provided by user 41 via user interface screen 70 shown in FIG. 6. BRM reports may show PR and PO timing, supply-chain performance, cash flow, and other financial performance to user 41 of IMARCS system 40 on an enterprise-wide and/or on a per-site scale. For example, FIG. 7 shows a PR backlog activity report 90 for the entire enterprise on a monthly basis from December 2005 to November 2006. For example, bar 92 in report graph 90 shows that for March 2006, 1480 new PRs were created while bar 94 shows that 1461 PRs were cleared and that the total backlog at the end of the month, represented by point 96, was 191 PRs. The graph may be further configured to show the linear progression of the PR backlog (shown as regression line or line of best fit 98 in FIG. 7), to see if the PR backlog is trending up or down or remaining generally the same over a certain period of time.

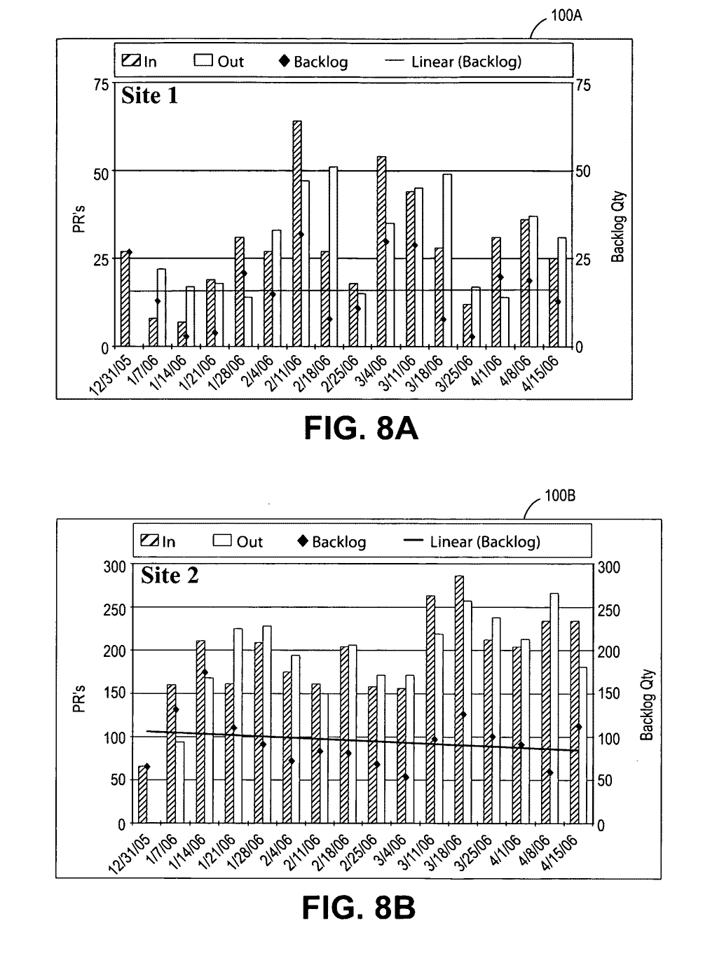

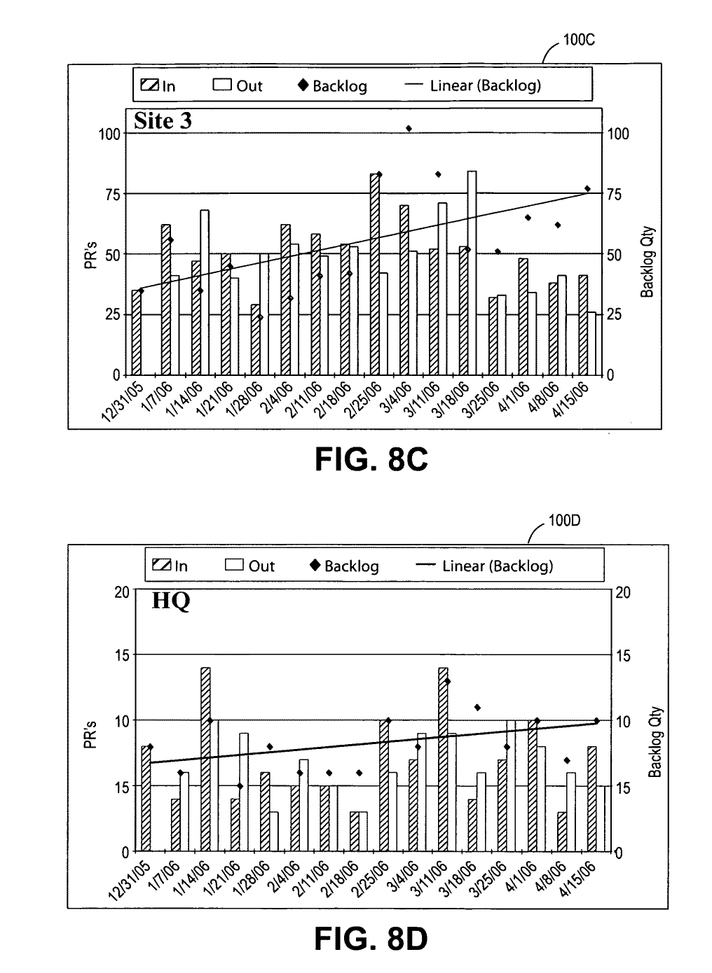

FIGS. 8A-8D show example reports 100A-100D that include the same data that is represented by report 90 in FIG. 7, but categorizes the data by buying site 48. For example, FIG. 8A represents an example PR backlog activity report 100A for a first buying site (e.g., NENS site 48A shown in FIG. 2), while FIGS. 8B and 8C show PR backlog activity reports 100B and 100C, respectively, for second and third buying sites (e.g., MOMS site 48B and SCNC buying site 48C shown in FIG. 2). FIG. 8D shows the PR backlog activity report 100D for the enterprise's headquarters 48D.

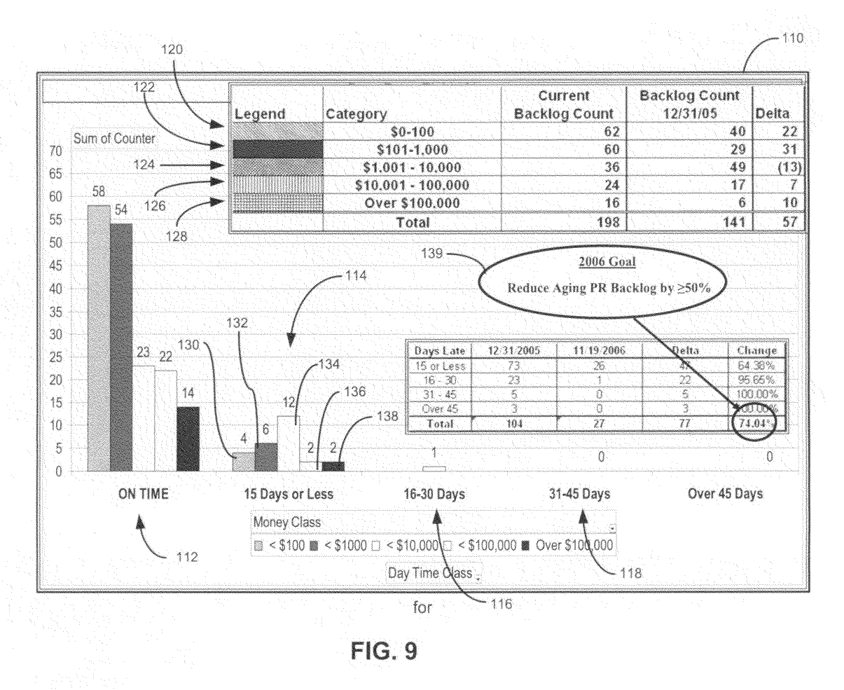

BRM 2425 may also be configured to generate reports on aging of backlogged PRs or to organize the backlogged PRs into groups based on aging. For example, PRs may be put into a group of “On Time” PRs (e.g. those that were completed by their due date and/or those with a due date in the future) and into backlog groups for a selected range of days. In an example report 110 shown in FIG. 9, backlogged PRs are placed in 15-day groups, such as a group of PRs 112 that were on time, a group of PRs 114 that are 15 days or less late, a group of PRs 116 that are 16 to 30 days late, a group of PRs 118 that are 31 to 45 days late, and so on. However, any range of days can be used (e.g., less than or greater than 15-day groups) and the backlog can be divided into any suitable range other than the days or less, 16-30 days late, 31-45 days late, and over 45 days late ranges shown in FIG. 9. In some examples, the range of days that are represented in a report generated by IMARCS system 40 can be selected by a user or can be predefined by IMARCS system 40.

BRM 2425 also may be configured to permit reporting based on dollar value ranges for the PRs. For example, in addition to reporting the PR backlog based on the number of days late, FIG. 9 also groups PRs by dollar value, such as a grouping 120 based on PRs less than $100, a grouping 122 between $100 and $999.99, a grouping 124 between $1000 and $9999.99, a grouping 126 between $10,000 and $99999.99, and a grouping 128 of $100,000 and over. BRM 2425 may also be configured so that the dollar value grouping described above is displayed for each aging group. For example, as shown in FIG. 9, group 114 of PRs that are less than 15 days late can be further split into subgroups based on dollar values, such as subgroup 130 representing PRs that are less than 15 days late with a dollar value of less than $100, subgroup 132 representing PRs that are less than 15 days late with a dollar value of between $101 and $1,000, subgroup 134 representing PRs that are less than 15 days late with a dollar value of between $1,001 and $10,000, subgroup 136 representing PRs that are less than 15 days late with a dollar value of between $10,001 and $100,000, and subgroup 138 representing PRs that are less than 15 days late with a dollar value of greater than $100,000. However, any range of dollar amounts can be used, e.g. less than or greater than grouping by the orders of magnitude grouping shown in FIG. 9. PR backlog can be divided into any suitable range of dollar amounts other than the $0-100, $101-1,000, $1,001-10,000. $10,001-100,000, and over $100,000 ranges shown in FIG. 9.

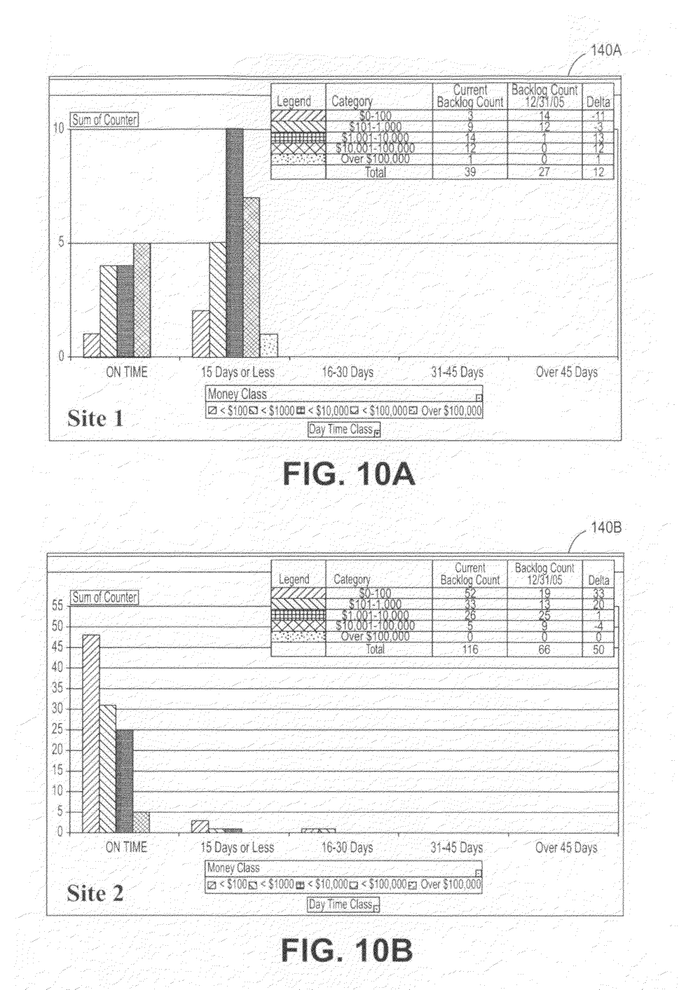

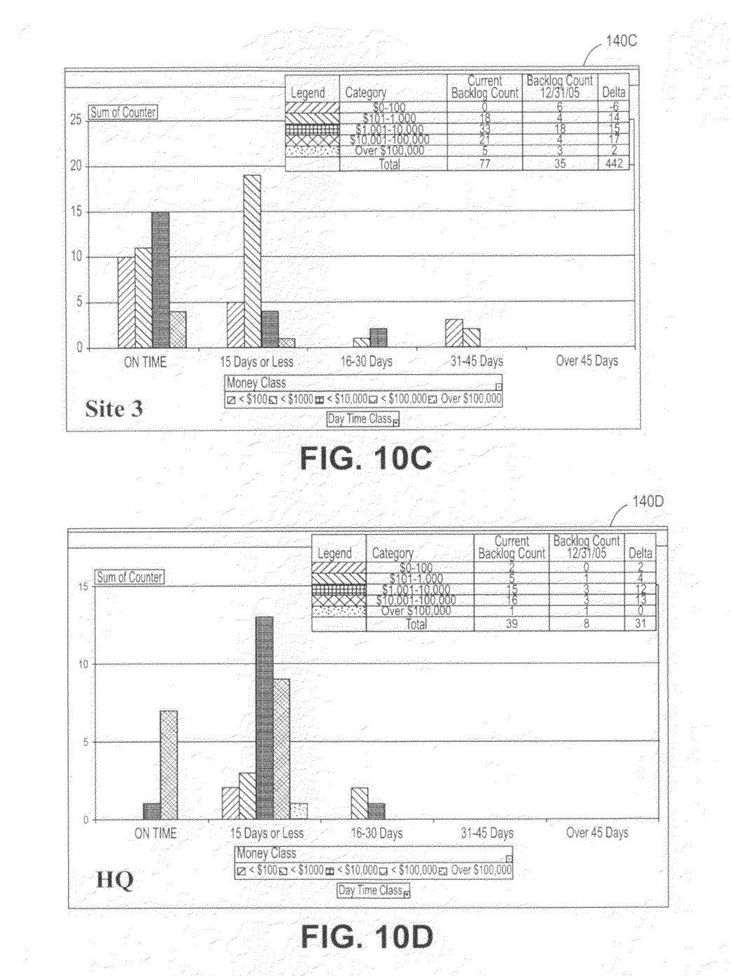

BRM 2425 may generate reporting based solely on the aging of PRs, or BRM 2425 may generate reporting based solely on the dollar value of PRs, or, as shown in FIGS. 9 and 10, BRM 2425 may generate reporting based on both aging and dollar value. In addition, BRM 2425 may be configured to create PR backlog aging reports on an enterprise wide-basis, as shown in FIG. 9, or on a per-site basis, as shown in FIGS. 10A-10D. For example, FIG. 10A represents an example PR backlog aging report 140A for a first buying site (e.g. NENS site 48A shown in FIG. 2), while FIGS. 10B and 10C show PR backlog aging reports 140B and 140C, respectively, for second and third buying sites (e.g. MOMS site 48B and SCNC site 48C shown in FIG. 2). FIG. 10D shows the PR backlog aging report 140D for the enterprise's headquarters 48D.

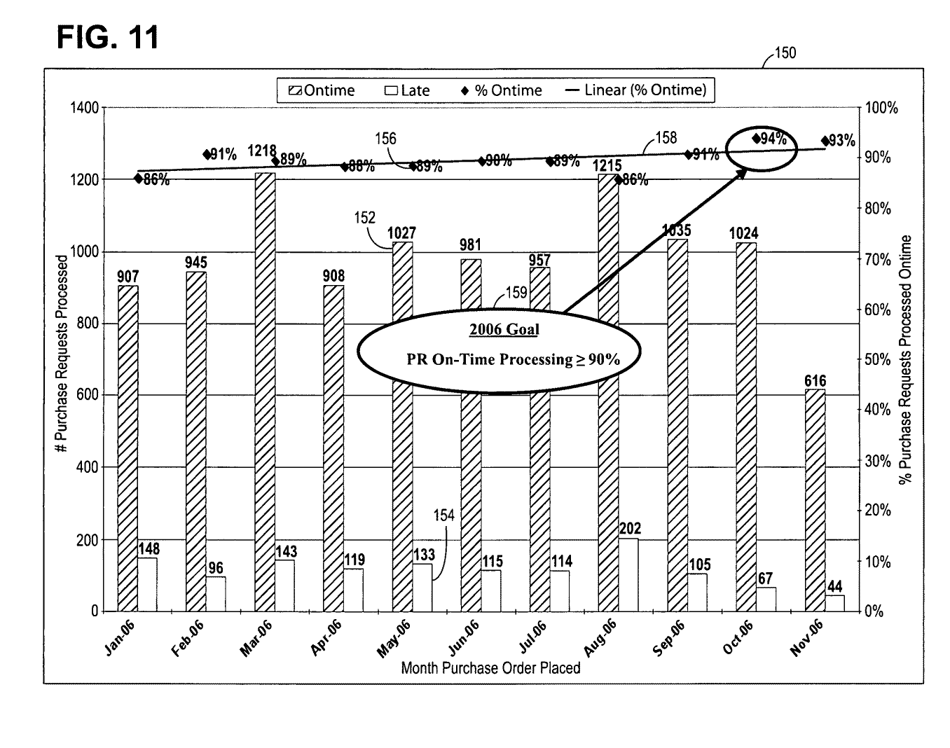

Turning to FIG. 11, in some examples, BRM 2425 is also configured to generate reports on PR on-time processing. As shown in FIG. 11, BRM 2425 may be able to generate a PR on-time report 150 showing the number of PRs that buyers processed on time and the number of PRs that buyers processed late for a given time period. In some examples, BRM 2425 can also generate reports that indicate the on time and late processing for regular time intervals, such as on a daily, weekly, monthly, or yearly basis, or for irregular custom time intervals selected by a user, so that a user may be able to detect trends in the effectiveness of buyers within the enterprise.

In one example, BRM 2425 generates a graph of on time and late PRs on a monthly basis, indicating the number of on time processed PRs, the number of late processed PRs, and a percentage of on time processed PRs for each month. In the example report 150 shown in FIG. 11, for example, bar 152 shows that in May 2006, 1027 PRs were processed on time, while bar 154 shows that 133 PRs were processed late, resulting in a total on-time percentage of 89%, as represented by point 156 in FIG. 11. BRM 2425 can also be configured to generate a trend line or line of best fit 158 corresponding to the percentage of on time processed PRs per month that allows a user to quickly see a trend of PR processing over time.

In some examples, IMARCS system 40 includes on-time delivery module (ODM) 2426 (FIG. 4) that generates reports useful for tracking and analyzing fulfillment and delivery of POs. In some examples, ODM 2426 generates reports based on user input (e.g., selecting the time range for the data presented in the reports). ODM 2426 is configured to generate reports on supplier performance, such as by reporting on PO on-time deliveries. As discussed above with respect to BRM 2425, ODM 2426 can automatically generate a predetermined number and type of reports, or ODM 2426 can generate a number and type of reports selected by a user.

FIG. 12 illustrates a PO on-time delivery report 160 generated by ODM 2426 that indicates the number of POs delivered on time or delivered late in a given period of time. ODM 2426 may also be able to generate reports regarding on time PO deliveries and late PO deliveries for regular intervals, such as on a daily, weekly, monthly, or yearly basis, so that user 41 may be able to detect trends in the effectiveness of suppliers to meet PO deadlines and of buyers to manage suppliers and keep the suppliers on task. User 41 can provide input via input device 2432 (FIG. 4) selecting the intervals for reporting PO data. Reports generated by ODM 2426 may be displayed on output unit 2434 of computing device 2400, such as a computer monitor or printer, to be viewed by user 41 of IMARCS system 40.

As with the on-time PR processing reports generated by BRM 2425 described above with respect to FIG. 11, ODM 2426 can generate graphs that illustrate on time and late POs on a monthly basis, indicating the number of on-time-delivered POs, the number of late-delivered POs, and a percentage of on-time-delivered POs for each month. For example, as shown in FIG. 12, for April 2006, a bar 162 indicates that 1291 POs were delivered on time, while bar 164 shows that 321 POs were delivered late, resulting in 80% of the POs being delivered on time, as indicated by point 166 in FIG. 12. ODM 2426 also may be configured to generate a trend line or line of best fit 168 corresponding to the percentage of POs that are delivered on-time per month that allows a user to quickly see the trend of PO on-time deliveries over time. Although FIG. 12 shows PO on-time deliveries on a monthly basis, any suitable time interval, such as daily, weekly, monthly, yearly, or irregular custom intervals may be used to report on on-time PO deliveries.

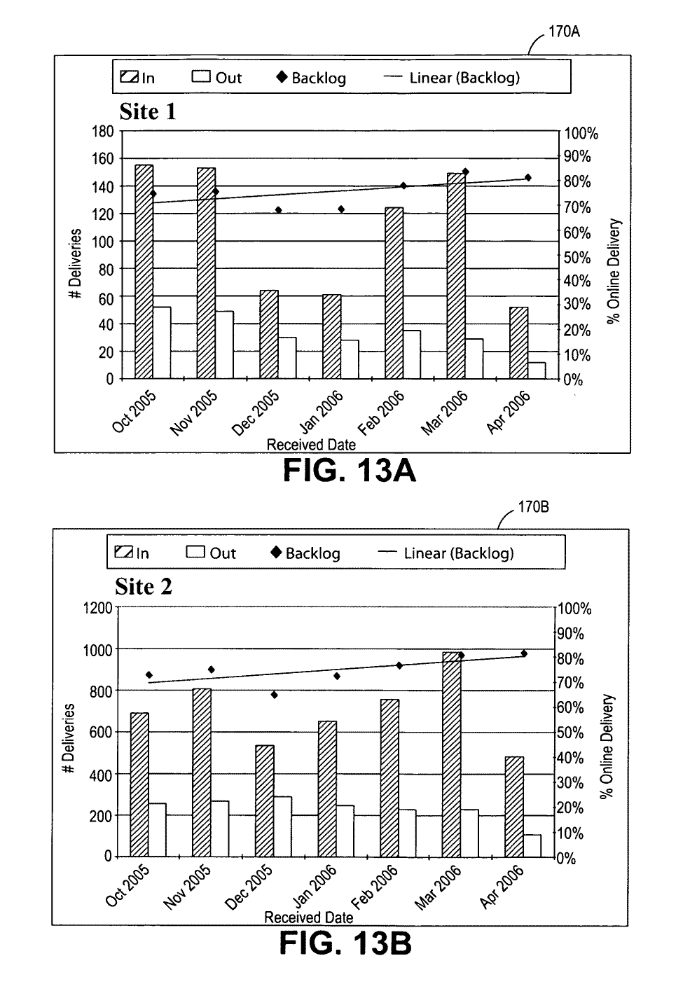

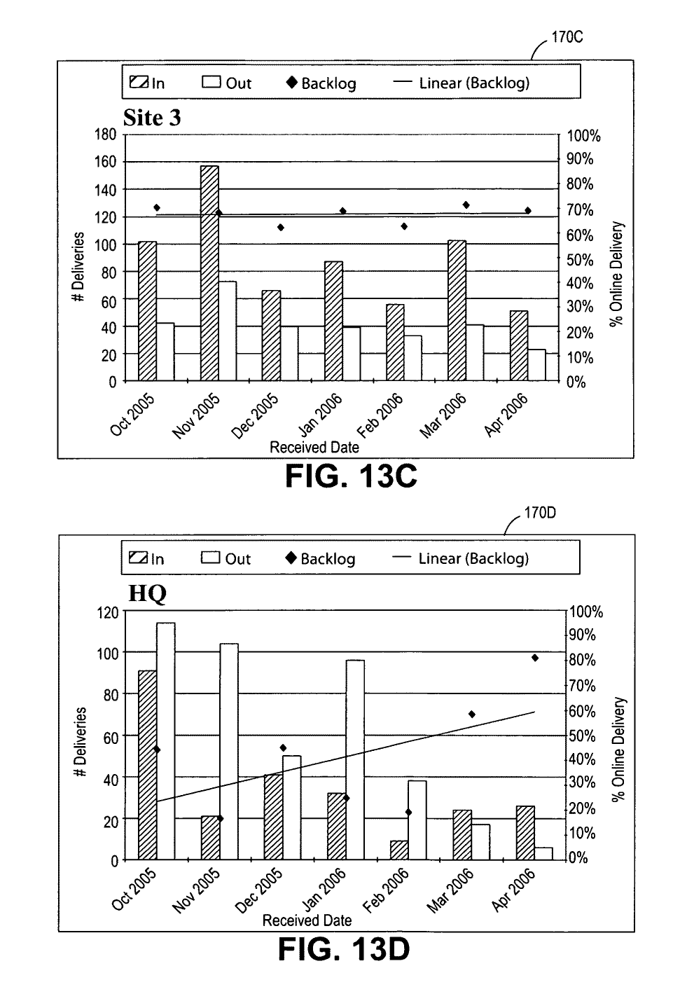

FIG. 12 shows a supplier delivery performance report generated by ODM 2426 on an enterprise-wide scale, while FIGS. 13A-13D show the same data in separate supplier delivery performance charts for each of a plurality of buyer sites. For example, FIG. 13A represents an example PO on-time delivery report 170A for a first buying site (e.g., NENS site 44A shown in FIG. 2), while FIGS. 13B and 13C show PO on-time delivery reports 170B and 170C, respectively, for second and third buying sites (e.g., MOMS site 44B and SCNC site 44C shown in FIG. 2), and FIG. 13D shows a PO on-time delivery report 170D for the enterprise's headquarters 44D.

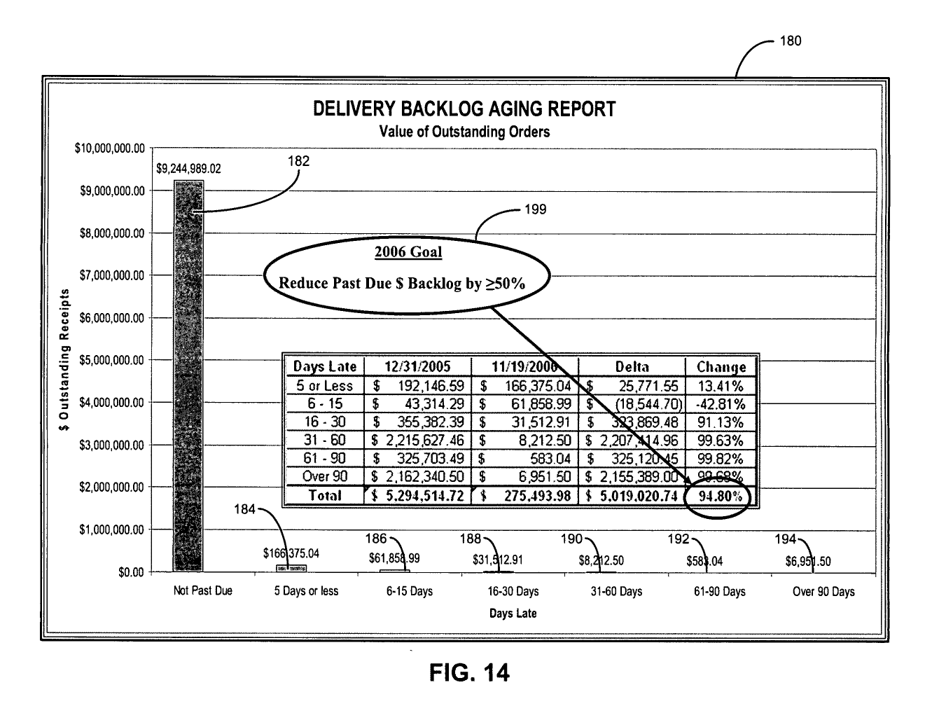

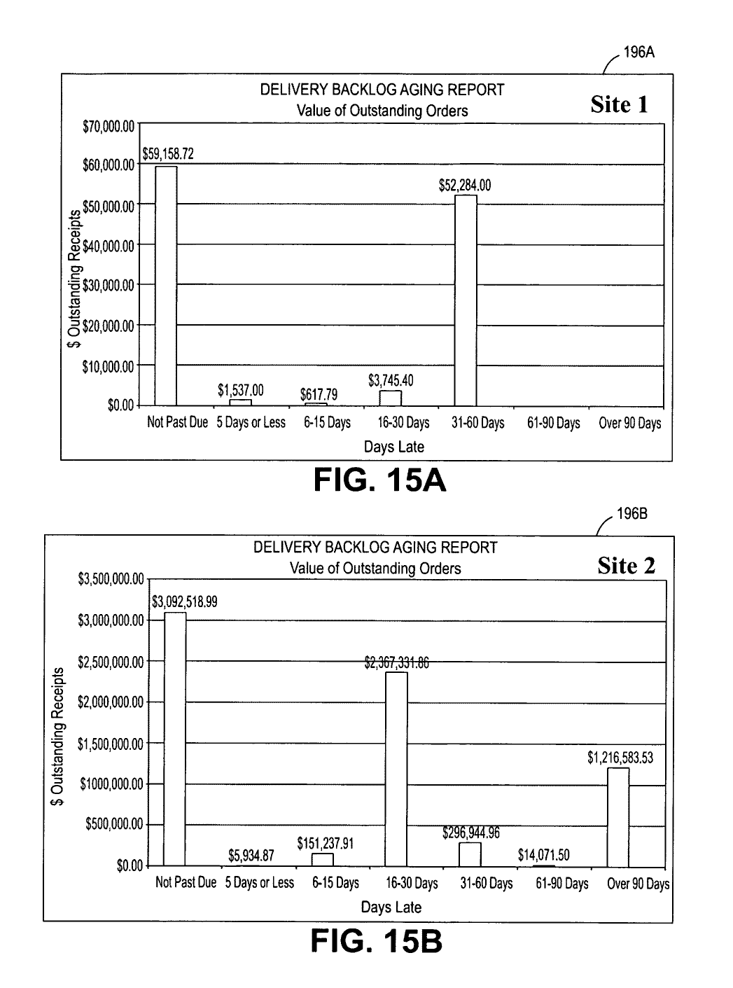

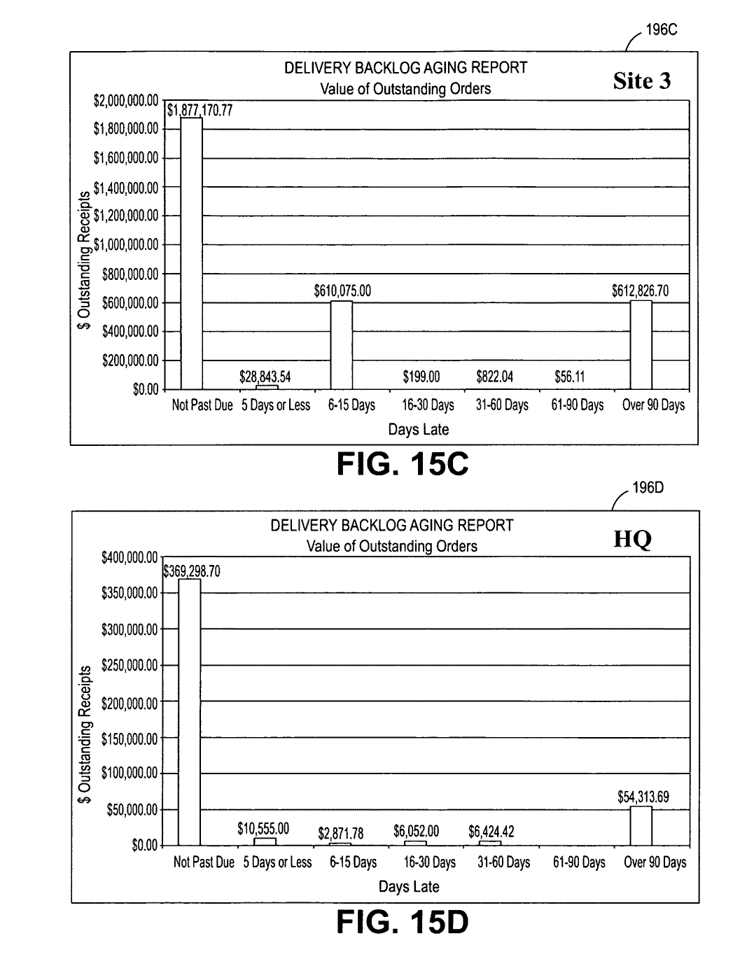

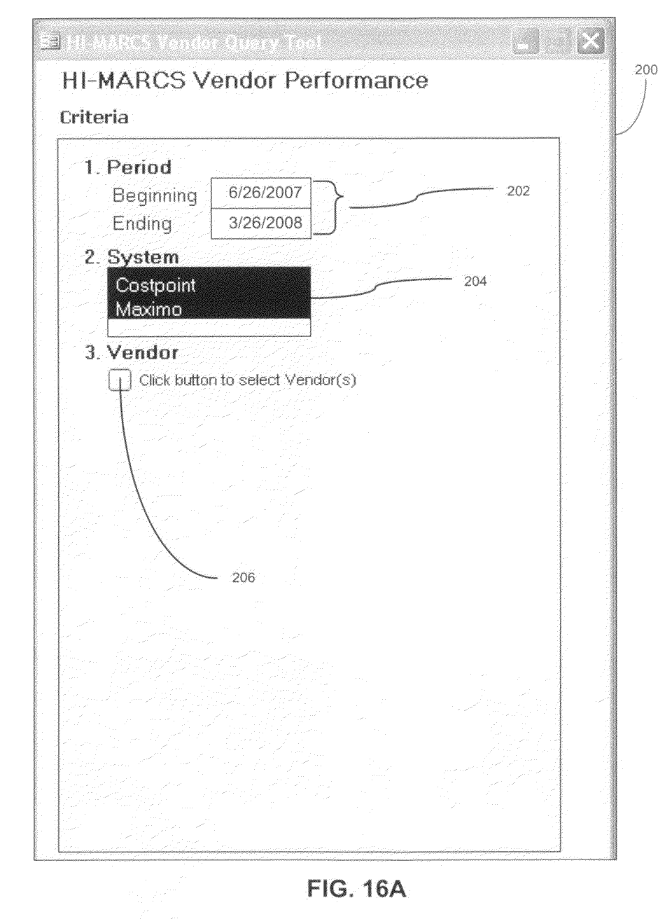

Turning to FIGS. 12 and 15A-15D, ODM 2426 may also be configured to generate reports on open PO delivery backlog aging. As shown in FIG. 14, an open PO delivery backlog aging report 180 may be configured to show data regarding POs that are not past due and data on POs for a number of past-due date ranges (e.g., selected by user 41 or automatically selected by ODM 2426). In some examples, PO delivery backlog aging report 180 can show this data by the total dollar value of open POs for each date range. In the example report 180 shown in FIG. 14, bar 182 shows the dollar value of open POs that are not past due, bar 184 shows the dollar value of open POs that are 5 days late or less, bar 186 shows the dollar value of open POs that are between 6 and 15 days late, bar 188 shows the dollar value of open POs that are between 16 and 30 days late, bar 190 shows the dollar value of open POs that are between 31 and 60 days late, bar 192 shows the dollar value of open POs that are between 61 and 90 days late, and bar 194 shows the dollar value of open POs that are greater than 90 days late. However, any range of days can be used (e.g., less than or greater than 5, 10, or 15-day groups) and the backlog can be divided into any suitable range other than the 5 days or less, 6-15 days late, 16-30 days late, 31-45 days late, or over 45 days late ranges shown in FIG. 14.

The information in a backlog aging report 180 and/or any other report described in this disclosure may be displayed graphically, textually, or both graphically and textually, as shown in the example report of FIG. 14. As with reports discussed previously, ODM 2426 may generate reports on PO delivery backlog aging on an enterprise-wide basis, as shown in FIG. 14, or for each of a plurality of individual buying sites, as shown in FIGS. 15A-15D. For example, FIG. 15A shows an example open PO backlog aging report 196A for a first buying site (e.g., NENS site 44A shown in FIG. 2), while FIGS. 15B and 15C show example open PO backlog aging reports 196B and 196C, respectively, for second and third buying sites (e.g., MOMS site 44B and SCNC buying site 44C shown in FIG. 2), and FIG. 15D shows an example open PO backlog aging report 196D for the enterprise's headquarters 44D.

IMARCS system 40 and its generated reports may drive, measure progress toward, and/or determine goals for the enterprise. IMARCS system 40 may also be configured to display the enterprise goals on reports so that user 41 can easily determine if supply-chain personnel are meeting the enterprise's goal. For example, FIG. 9 shows a PR backlog activity goal 139 in PR backlog activity report 110 as “Reduce Aging PR Backlog by ≧50%,” FIG. 11 shows a PR backlog aging goal 159 in PR backlog aging report 150 as “PR On-Time Processing Goal ≧90%,” FIG. 12 shows a PO on-time delivery goal 169 in PO on-time delivery report 160 as “PO On-Time-Delivery to ≧90%,” and FIG. 14 shows a PO deliver backlog aging goal 199 in PO backlog aging report 180 as “Reduce Past Due $ Backlog by ≧50%.” IMARCS system 40 can automatically provide reports containing goals 139, 159, 169, and 199 to user 41 (e.g., such as a buyer or manager of the enterprise or working with the enterprise) such as by transmitting (e.g., by e-mail, facsimile or the like) or otherwise presenting a report 110, 150, 160, and 180 to user 41 whenever the report is created so that 41 user automatically determine whether the enterprise is meeting its goals while reviewing reports 110, 150, 160, and 180. If the reports indicate that the enterprise is not meeting its goals, user 41 may determine how large the discrepancy is between the goals and the enterprise's performance and take corrective action. The visual display of enterprise performance relative to predetermined goals can provide concrete metrics with which user 41 can formulate a corrective action.

In some examples, IMARCS system 40 includes vendor performance module (VPM) 2427, which provides functions that allow users of IMARCS system 40 to track the performance of vendors in supplying materials needed in the enterprise's supply-chain and to report on vendor performance across multiple purchasing systems. FIGS. 16A-19 show views of example reports generated by an example VPM 2427 of IMARCS system 40. The views and reports generated by VPM 2427 may be displayed on output unit 2434 of computing device 2400, such as a computer monitor or printer, to be viewed by user 41 of IMARCS system 40. FIG. 16A shows one example view of a query tool user interface screen 200 presented by VPM 2427 that allows a user to track vendor performance based on a particular time period, such as 3 months or 6 months, or by providing input specifying a custom date range in fields 202, as shown in FIG. 16A. Query tool user interface screen 200 also allows a user to select one or more data sources or “Systems” in field 204, such as selecting by one or more supply-chain DBs 44 or, as shown in FIG. 16A, by type of supply-chain database (shown as Costpoint or Maximo in FIG. 16A).

Query tool user interface screen 200 may also allow user 41 to narrow a search to specific vendors. In the examples shown in FIGS. 16A and 16B, user 41 can select button 206 in the window shown in FIG. 16A, which opens a vendor search user interface screen 208, shown in FIG. 16B, that has one or more search fields, such as search fields 210A, 210B, 210C, 210D, and 210E (referred to collectively as “search fields 210”), which allow user 41 to provide input entering one or more vendor names or vendor IDs to permit analysis of a single vendor or comparison between vendors. After entering one or more vendor names or vendor IDs in search fields 210, user 41 may select the Begin Vendor Search button 212 via an input device, such as input unit 2432 of FIG. 4, to begin the search and receive results on vendors.

VPM 2427 presents a user interface screen to user 41 that permits user 41 to view information about the selected vendors (e.g., vendor name, vendor identification number, location, phone number, and the like). An example vendor search results user interface screen 214 is shown in FIG. 16C, which includes a results window 216 and also includes search fields 218A, 218B, 218C, 218D, and 218E (referred to collectively as “search fields 218”) that are similar to search fields 210 of vendor search window 208 so that user 41 can easily determine the selected vendors or to enter new search terms and run a new search. A vendor search component of VPM 2427 can support different search techniques, such as prefix term searching, wildcard searching, Boolean searching, and the like. In one example, best shown in vendor search results user interface screen 214 shown in FIG. 16C, the user can enter the exact name known, such as the search for “Allied Electronics” in search field 218A in FIG. 16C, or the user may run a truncated search with a wildcard character, such as the search in field 218C for “McMaster %” that returns results including “MCMASTER-CARR Supply Co.” in results window 216.

As described above, in some examples, VPM 2427 generates reports that compare two or more vendors. FIG. 16C shows an example search results window 216 for comparing three vendors. The example results window 216 includes one row per vendor, with each row including a column for a vendor ID 220, vendor name 222, and vendor contact information including mailing address 224, city 226, state 228, ZIP code 230, and phone number 232. VPM 2427 can determine the on-time percentage for deliveries for each of the vendors and display the percentages to the user (not shown in FIG. 16C), such as via a user interface screen 2430 of computing device 2400 shown in FIG. 4.

Each particular vendor may have several supply sites that are used by the enterprise using IMARCS system 40. For example, as shown in FIG. 16C, the “Allied Electronics” vendor in search field 218A has five different vendor sites, each with a unique vendor ID number. The search results window 216 may also include an indication of which search field 218 a particular vendor result is associated with. For example, in FIG. 16C, column 234 shows that the first five results correspond to the search field 218A, designated with a “1,” while the next eight results correspond to search field 218B, designated with a “2,” and the remaining three search results shown in results report window 216 correspond to search field 218C, designated with a “3.” In the example shown in FIG. 16C, the search results report window 216 also allows VPM 2427 to limit results to those vendors with open receipts, such as by receiving user input by a user selecting check box 236 with in put unit 2432, or to select all vendors in the results report window 216 by selecting button 238 with a user input unit 2432, such as a keyboard, a mouse, a touch screen or another peripheral pointing device. Once a user has selected all the vendor results she wishes to examine in VPM 2427, the user may select button 240 via an input device to allow VPM 2427 to create a report for the selected vendors.

FIG. 16D shows an example on-time percentage report user interface screen 242 generated by VPM 2427, which illustrates the on-time percentage for vendors selected using VPM 2427. In one example, computing device 2400 can automatically generate on-time percentage report user interface screen 242, e.g., in response to receiving user input selecting button 240 in FIG. 16C via user input device 2432. The example report user interface screen 242 shown in FIG. 16D includes an on-time report window 244 that indicates combined results for all vendor(s) selected during the vendor search, such as the vendor search described above with respect to FIGS. 16B and 16C. Report window 244 may include data for various time periods including the on-time delivery percentage 246, the number of on time deliveries 248, and the total number of receipts (received deliveries) for all selected vendors 250. Other types of data or fields can also be shown via on-time percentage report user interface screen 242. For example, the example report user interface screen 242 shown in FIG. 16C may also include fields 252 for entering a time period of interest, similar to fields 202 in FIG. 16A, a field 254 for selecting one or more data sources or “Systems,” similar to field 204 in FIG. 16A, and a field 256 showing the vendors that are included in the results of report window 244, which correspond to the vendors selected in the vendor search results user interface screen 214 of FIG. 16B.

User 41 may also select a button 258, which is similar to button 206 in FIG. 16A, which permits user 41 to change the selection of vendors that are included in the results in report window 244. In one example, selecting button 258 will open either the vendor search user interface screen 208 of FIG. 16B or the vendor search results user interface screen 214 of FIG. 16C. VPM 2427 also may be used to combine numbers of vendors, provide more detail about a specific reported time period, and/or compare vendors. For example, as indicated in FIG. 16D, a user may select a particular time period and view all POs for that time period, such as by double-clicking via input unit 2432 on the on-time percentage number or one of the other data points for that particular time period. For example, to view the PO data for the “3 months” time period of FIG. 16D, a user may double-click on the “97.2%” representing the percentage of on-time POs for that time period, or the “410” representing the number of on-time POs, or the “422” representing the total number of received deliveries for that time period.

VPM 2427 may also be configured to generate a report that compares the on-time POs for all selected vendors, such as by selecting the Compare Vendors button 260 shown in FIG. 16D with input unit 2432. FIG. 16E shows an example report user interface screen 262 that VPM can generate on output unit 2434 of computing device 2400 (FIG. 4), where report user interface screen 262 shows a comparison of selected vendors. In the example shown in FIG. 16C, after a user selects specific vendors to be compared, such as through the vendor search user interface screen 214 of FIG. 16C, and, if necessary, indicates that the user would like a report comparing PO deliveries for the selected vendors, such as by selecting the Compare Vendors button 260 in FIG. 16D, VPM 2427 generates a report, such as the report shown in report window 264 of report user interface screen 262, comparing the PO on-time percentage for the selected vendors over various time periods, thus allowing for easy comparison of on-time percentages for the selected vendors. If a user decides she would rather view the overall on-time delivery data, such as that shown in report window 244 in FIG. 16D, than the user may simply click button 266 which deselects the “Compare Vendors” option and returns the user to FIG. 16D. The other fields or buttons shown in FIG. 16E are essentially identical to fields 252, 254, 256, and button 258 described above with respect to FIG. 16D.

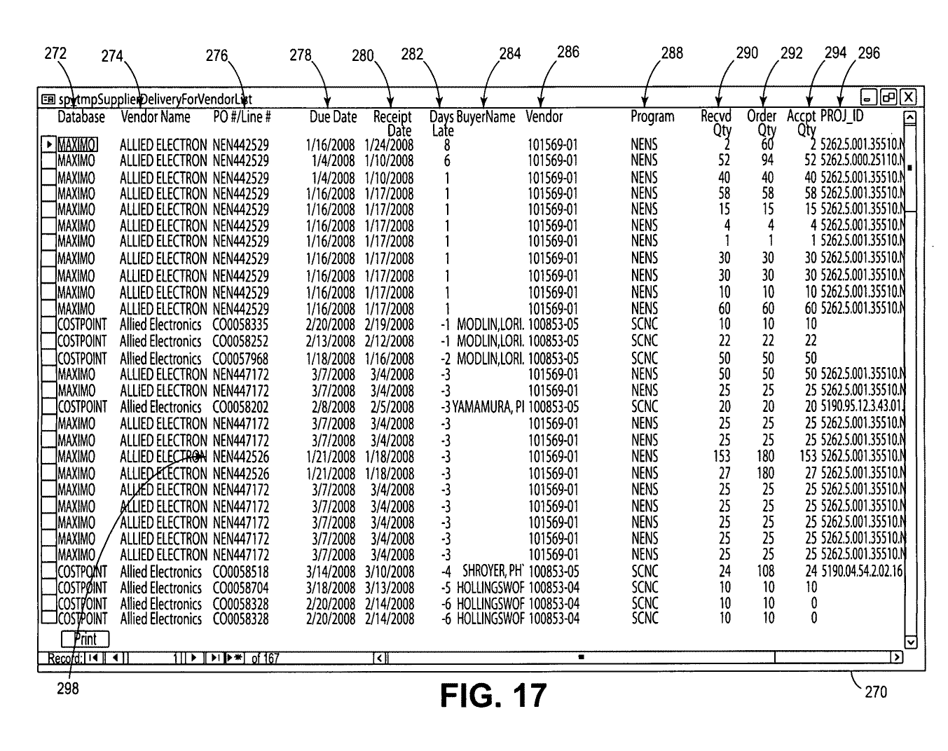

In some examples, VPM is configured to generate detailed drill-down reports for a particular vendor, where the reports can include, for example, all POs received from a selected vendor in a selected time period so that a buyer may examine the selected vendor's performance on each individual PO and determine more details regarding the vendor's performance compared to the detail provided in the overall on-time percentage report user interface screen 262 shown in FIG. 16E. FIG. 17 shows an example vendor drill-down report 270 that may be generated by VPM 2427. The example vendor-drill-down report 270 may be generated by a user of VPM 2427 selecting a specified time period for a specific vendor, such as by double-clicking via input unit 2432 on the desired time period for a particular vendor in results window 264 of FIG. 16E. The example vendor drill-down report 270 shown in FIG. 17 was created by user 41 providing user input selecting the three-month time period for the Allied Electronic vendor by selecting the “93.4%” number with input unit 2432 under the “3 Mo” heading in the results window 264 in FIG. 16E, prompting VPM 2427 to create vendor drill-down report 270 shown in FIG. 17.

The vendor-drill-down report 270 may have one or more rows of data with each row including columns of data that may include any information that may be useful to the enterprise in tracking POs, such as columns indicating the system or database where the data for that row came from 272, such as Maximo DB 44A or Costpoint DB 44B (other databases can also be used with IMARCS system 40) shown in FIG. 2, the vendor name 274, a PO number 276, a due date 278, a receipt date 280, a number of days late 282, the name of a buyer 284 within enterprise responsible for the PO, a vendor ID number 286, a “program” 288 specifying a contract or other reason for which materials were ordered, quantities of materials received 290, quantities of materials ordered 292, quantities of materials accepted 294, and a project ID for the program 296. The “number of days late” column 282 may also be configured to show the number of days early for early deliveries, such as by showing an early delivery as being a negative number of days late, such as PO NEN442526, designated with reference number 298 in FIG. 17, that was received three days early and is as “−3” days late in FIG. 17.

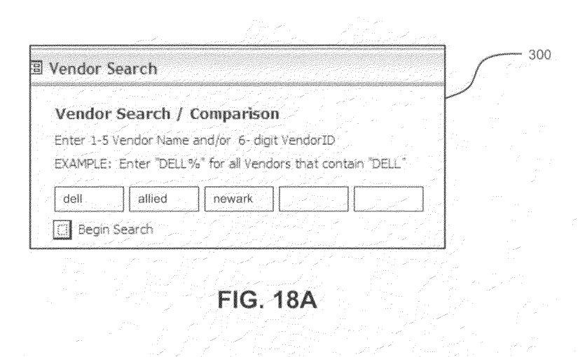

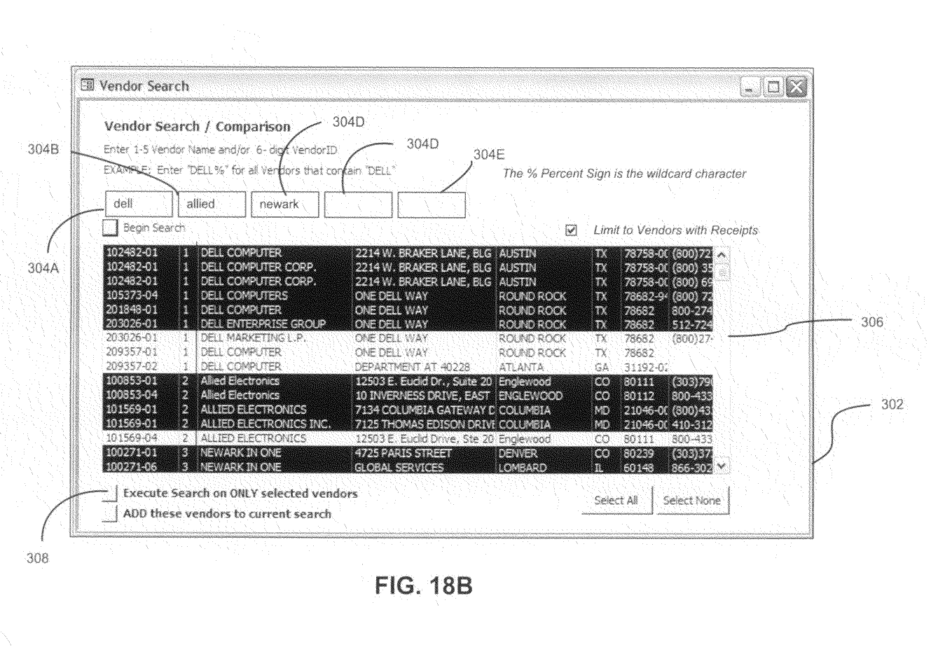

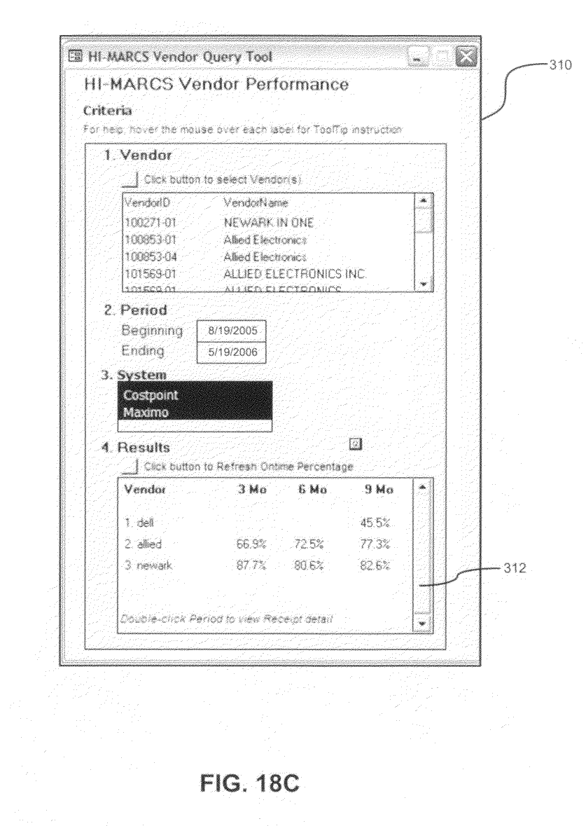

As shown in FIGS. 18A-18C, in some examples, VPM 2427 can be configured to receive user input selecting a subset of vendors from the vendor search results in a vendor search results user interface screen. VPM can generate reports that indicate the performance of the selected vendors. FIGS. 18A and 18B show example vendor search user interface screen 300 and a vendor search results user interface screen 304 that are identical to the example vendor search user interface screen 208 of FIG. 16B and the vendor search results user interface screen 214 of FIG. 16C except for the vendor terms entered into search fields 304A, 304B and 304C (referred collectively to as “search fields 304”). The example vendor search results user interface screen 302 shown in FIG. 18B permits a user to enter all or portions of a vendors name or vendor ID in order to search for vendors. VPM 2427 may be configured so that it will retrieve results for all vendors that start with the same text as is entered into search fields 304 unless a truncation or wild card character (such as the “%” shown in FIG. 16C) is used. For example, the search term “dell” entered in search field 304A results in search results that include “Dell Computer,” “Dell Computer Corp.,” and “Dell Marketing,” as shown in FIG. 18B. VPM 2427 may be configured to allow selection of fewer than all the vendor results, so that a user may get data for the exact set of vendors desired.

In the example shown in FIG. 18B, after a search for the terms “dell,” allied,” and “newark” returned the results shown in search results window 306, user 41 may select any combination of the vendors to return results only for those selected vendors. For example, user 41 of the example VPM 2427 of FIG. 18B has selected the first six results for the “dell” search (as indicated by the dark highlighting of the first six rows in search results window 306) leaving the last three results unselected. The user of the example VPM 2427 of FIG. 18B has also selected the first four results for the “allied” search and left the last remaining result unselected and the user has also selected both results from the “newark” search. After selecting the desired set of vendors, VPM 2427 may be prompted to generate a report of vendor performance for the selected vendors, such as by the user clicking button 308 labeled “Execute Search on ONLY selected vendors” in FIG. 18B. VPM 2427 may be configured to generate a report user interface screen 310 on vendor performance for the selected vendors, such as the on-time percentage data shown in results window 312 in FIG. 18C, which is similar to the results user interface screen 262 and results window 264 shown and described above with respect to FIG. 16E.

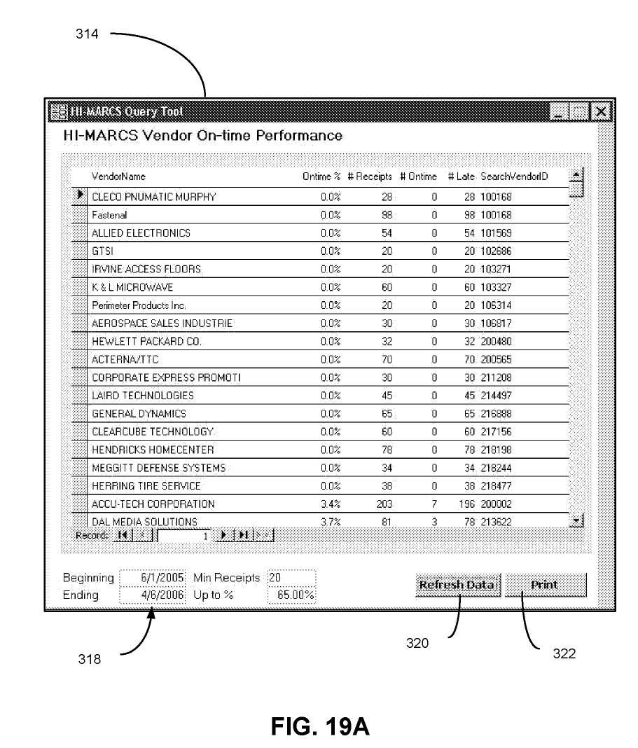

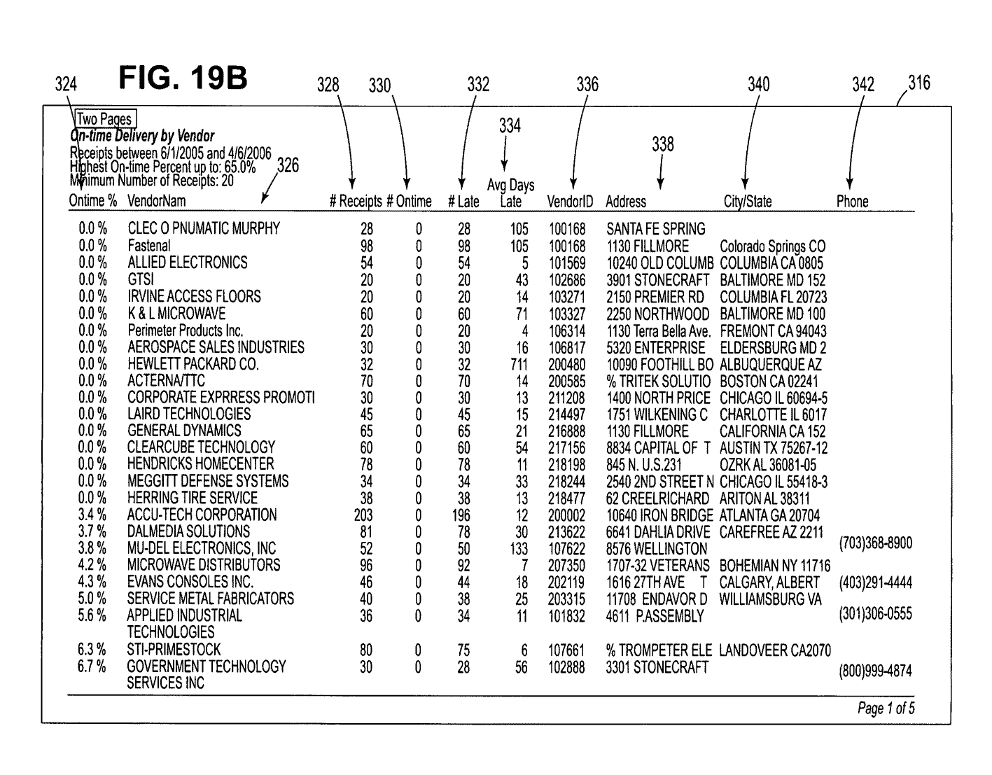

In another example, VPM 2427 generates a report of the on-time performance for vendors meeting specified criteria, which can be, for example, specified by a user. Examples of specified criteria include, but are not limited to, a specific time period that POs are received (e.g., fulfilled) by vendors, a maximum or minimum on-time percentage, or a minimum number of receipts, as shown in the example query tool user interface screen 314 shown in FIG. 19A. After receiving user input selecting values for the specified criteria, VPM 2427 generates a report of vendors that meet the specified criteria, such as the example vendor on-time performance report 316 shown in FIG. 19B. VPM 2427 may also be configured to allow a user to change the specified criteria and run a new report quickly and easily, such as through the use of data entry fields 318 and a refresh button 320 shown in FIG. 19A.

VPM 2427 may also be configured to generate a full report on on-time vendor performance in a form that is relatively easily legible and provides for easy-to-understand reporting, such as by clicking a “Print” button 322 that causes VPM to create a full report, such as report 316 shown in FIG. 19B. An example report 316 may include a row of data for each vendor and may include columns of data regarding each vendor, such as columns for the actual on-time percentage 324 within the specified time period, vendor name 326, number of receipts from the vendor 328 within the specified time period, the number of on-time deliveries 330 within the specified time period, the number of late deliveries 332 within the specified time period, the average number of days late for the late delivers 334, a vendor ID 336, and vendor contact information such as address 338, city and state 340, and phone number 342. The report 316 may be displayed on an output device such as a computer monitor, exported to a data file (e.g., to a spreadsheet file such as a Microsoft Excel spreadsheet, a flat file, or a binary file, perhaps formatted for importing data into a database, or to an Adobe PDF file), printed out as a paper report that is sent to a printer or other reproduction device, and/or e-mailed or otherwise transmitted.

An enterprise can implement IMARCS system 40 to help improve supply-chain management, including to reduce the open PR backlog, reduce the past due PR backlog, increase on time PR placement, reduce vendor past-due backlog on the basis of number of POs or dollar value of the backlog, and to increase supplier on time delivery. In one example implementation within an enterprise, within a period of about six to nine months of implementing the IMARCS system 40 based on approximately 37,000 observations, the open PR backlog was reduced by 25%, the past due PR aging backlog was reduced by 78%, on time PR placement was increased by 19% to a total of over 90% and the supplier on time delivery was increased by 44%. These improvements may translate into bottom line results as well by decreasing the dollar amount of the vendor backlog and thus freeing up working capital, increasing revenue, and also increasing operational income.

Further, the simplicity and ease of reporting using the IMARCS system 40 may have beneficial staffing effects. For example, the amount of time spent administering the supply-chain may be reduced and/or buyers and other supply-chain personnel can be moved within the enterprise to aid busy and/or understaffed sites because tracking of buyer performance can be performed on a site-by-site basis. In one example, IMARCS system 40 is configured to recognize when a particular buying site or buyer is exceeding expectations on PR and/or PO turnaround and may increase the workload of the buying site or buyer to exploit this situation. Similarly, the IMARCS system 40 may be configured to recognize when a particular buying site or buyer is backlogged beyond its expectations and may either back off the workload that is assigned to the buying site or buyer or may shift some of the PR backlog to a different buying site or buyer.

For example, a first buying site and a second buying site, such as the NENS buying site 48A and the MOMS buying site 48B shown in FIG. 2, may be assigned to manage a particular portion of the enterprise's supply-chain. During the course of fulfilling the supply-chain requirements of the enterprise, NENS buying site 48A may be expected to meet a particular metric, such as an expected average PR turnaround, for example a five-day average turnaround, but may actually be exceeding the expected metric, such as by having a faster average turnaround, for example a three-day turnaround, resulting in little or no PR backlog. MOMS buying site 48B may also be expected to meet a particular metric, such as the same five-day average turnaround, but may actually be falling short of meeting the metric, such as by having a much larger average turnaround, for example a 15-day average turnaround, resulting in an undesirably large PR backlog. IMARCS system 40 may recognize the disparity between NENS buying site 48A and MOMS buying site 48B and may reassign some of the backlogged PRs of MOMS buying site 48B to NENS buying site 48A for fulfillment to exploit the underworked nature of the NENS buying site 48A and to alleviate the overworked nature of the MOMS buying site 48B. Metrics in addition to or instead of the average PR turnaround may be used, such as average number of days for a buyer to create a PO, the cycle time for a particular order (e.g., the average number of days between PR creation and receipt of goods), the percentage of on-time deliveries or late deliveries for all shipments corresponding to a buyer's POs for a given time period (e.g., a weekly or monthly basis), the percentage of on-time or late deliveries for all shipments corresponding to a buyer's POs for a specific time period (e.g., the previous or current week or month), or the volume of POs for the particular buying site by dollar amount.

This shifting of PRs or POs may be performed automatically by IMARCS system 40 upon fulfillment of certain backlog benchmarks, such as by a buying site failing to meet a specific average turnaround time or some other metric. Alternatively, IMARCS system 40 may simply generate backlog reports, either automatically or upon a user's request, to a user of IMARCS system 40, such as a manager responsible for monitoring the workload of NENS buying site 48A and MOMS buying site 48B, that allows the user to manually redirect resources to different buyers or buying sites as she sees fit. Thus, IMARCS system 40 may allow for quick realigning of the enterprise's supply-chain resources to provide for efficient fulfillment of supply-chain needs. The supply-chain personnel may be cross-trained to use multiple supply-chain databases to permit flexibility in moving personnel. Further, depending on the capabilities of the heterogeneous network 42 of supply-chain databases 44, supply-chain personnel may be able to remotely administer the supply-chain at a given site, saving overhead as well.

IMARCS system 40 may also be configured to generate a forum that allows an enterprise's supply-chain personnel to view reports from IMARCS system 40 to provide buyers, managers, and other supply-chain personnel with information in a timely and easy-to-grasp fashion, as well as indicating how supply-chain performance is being monitored. In one example, this provision of the reports of IMARCS system 40 allows reports to be shown to a wide audience, such as printing or electronically publishing reports in a central location viewable by many employees within the enterprise, referred to in this disclosure as a “visual workplace.” The publishing of IMARCS reports in the visual workplace allows those in the supply-chain to more readily align their performance with the metrics, fosters healthy competition, reports performance trends, communicates results, identifies any areas for performance, and recognizes the performance of individuals, teams, and the entire enterprise.

An example of a visual workplace 344 is shown in FIG. 20, wherein visual workplace 344 is shown as a physical bulletin board 346 on which reports generated by IMARCS system 40 are on display. Examples of reports that can be displayed on physical bulletin board 346 include, but are not limited to, PR backlog activity report 90 described above with respect to FIG. 7, PR backlog aging report 110 described above with respect to FIG. 9, PR on-time processing report 150 described above with respect to FIG. 11, PO on-time delivery report 160 described above with respect to FIG. 12, or PO backlog aging report 180 described above with respect to FIG. 14. Similarly, visual workplace 344 may display reports on a per-site basis, such as PR backlog activity reports 100A-100D shown in FIGS. 8A-8D, PR backlog aging reports 140A-140D shown in FIGS. 10A-10D, on-time delivery reports 170A-170D shown in FIGS. 13A-13D, or PO backlog aging reports 196A-196D shown in FIGS. 15A-15D, in order to provide a sense of competition between buying sites or between buyers. Although FIG. 20 shows visual workplace 344 as a physical bulletin board 346 that is posted at one or more buying sites 48, in other examples, the visual workplace can be in electronic form. For example, a visual workplace including various reports generated by IMARCS system 40 based on data from a plurality of databases can be posted on an internet website or on the enterprise's internal network or may be delivered regularly to buying sites or buyers, such as through a regular company newsletter or e-mail.

As described in this disclosure, IMARCS system 40 can be useful for improving communication within an enterprise (e.g., to redistribute resources), as well as raising awareness and building confidence that the enterprise's supply-chain can meet customer need dates because results are communicated regularly daily to buyers (e.g., on a daily basis), and reported and posted regularly (e.g., on a monthly basis). Buyers and managers of the enterprise can utilize IMARCS to monitor the workload of buying sites or buyers and prioritize backlog activity on a regular basis (e.g., daily or weekly). In addition, based on data accumulated by IMARCS system 10, operations personnel, such as buyers, are aware of and can monitor status and obtain feedback on a regular basis (e.g., such as daily). Moreover, IMARCS system 40 helps an enterprise prioritize and track urgent/expedited requirements on a regular basis (e.g., such as daily). IMARCS system 10 provides metrics that improve an enterprise's internal functions, which can increase the internal and external customer's confidence that mandated deadlines can be achieved.

The techniques described in this disclosure, including those attributed to computing device 47, computing device 2400, or various constituent components, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in computing devices. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. While the techniques described in this disclosure are primarily described as being performed by processor 2410 (and respective modules) of computing device 2400, any one or more parts of the techniques described in this disclosure may be implemented by a processor of more than one computing device, alone or in combination with each other.

In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, magnetic data storage media, optical data storage media, or the like. The instructions may be executed to support one or more aspects of the functionality described in this disclosure.

This disclosure refers to illustrative examples that are not meant to be construed in a limiting sense. Various modifications of the illustrative examples, as well as additional embodiments of the invention, will be apparent to persons skilled in the art upon reference to this description.

1. A method for generating reports based on data from a plurality of databases, the method comprising:
determining a plurality of common data fields for the plurality of databases;
receiving data from each of the plurality of databases regarding one or more procurement items, wherein the data for each of the one or more procurement items comprises data corresponding to each of the common data fields; and
generating one or more reports about the one or more procurement items based on the requested data.

2. The method according to claim 1, wherein the data regarding the one or more procurement items comprises supply-chain data for a common enterprise.

3. The method according to claim 1, wherein the data regarding the one or more procurement items comprises one or more material service requests (MSRs), one or more work orders (WOs), one or more purchase requisitions (PRs), and one or more purchase orders (POs) for an enterprise.

4. The method according to claim 1, wherein the one or more reports comprise one or more reports on purchase requisition backlog activity.

5. The method according to claim 1, wherein the one or more reports comprise one or more reports on purchase requisition backlog aging.

6. The method according to claim 1, wherein the one or more reports comprise one or more reports on purchase requisition on-time processing.

7. The method according to claim 1, wherein the one or more reports comprise one or more reports on purchase order on-time delivery.

8. The method according to claim 7, wherein the one or more reports on purchase order on-time delivery include one or more reports on on-time delivery performance on a per vendor basis.

9. The method according to claim 7, wherein the one or more reports on purchase order on-time delivery include a breakdown of on-time delivery on a per purchase order basis.

10. The method according to claim 1, wherein the one or more reports comprise one or more reports on purchase order backlog aging.

11. The method according to claim 1, further comprising generating a forum to post one or more of the generated reports for viewing by employees of an enterprise.

12. The method according to claim 1, wherein the databases store data relating to a supply-chain of a common enterprise.

13. The method according to claim 1, further comprising determining instantiation of each of the plurality of common data fields for each of the plurality of databases prior to receiving the data from each of the plurality of databases.

14. A system comprising:
a user interface comprising a display; and
one or more processors configured to:
determine a plurality of common data fields for a plurality of databases,
receive data from each of the plurality of databases regarding one or more procurement items, wherein the data for each of the one or more procurement items comprises data corresponding to each of the common data fields, and
generate one or more reports about the one or more procurement items based on the requested data, and present the one or more reports to a user via the display of the user interface.

15. The system according to claim 14, wherein the one or more processors are further configured to determine the plurality of common data fields based on user input received via the user interface.

16. The system according to claim 14, wherein the user interface comprises a user input device, and the one or more processors are configured to receive user input indicating one or more report parameters and generate the one or more reports based on the one or more report parameters.

17. The system according to claim 14, wherein the one or more processors are further configured to determine instantiation of each of the plurality of common data fields for each database of the plurality of databases prior to receiving the data from the plurality of databases.

18. A computer-readable storage medium comprising instructions that cause a programmable processor to:
determine a plurality of common data fields for a plurality of databases;
receive data from each of the plurality of databases regarding one or more procurement items, wherein the data for each of the one or more procurement items comprises data corresponding to each of the common data fields; and
generate one or more reports about the one or more procurement items based on the requested data, and present the one or more reports to a user via the display of the user interface.

19. The computer-readable storage medium according to claim 18, further comprising an instruction that causes the programmable processor to determine the plurality of common data fields based on user input received via the user interface.

20. The computer-readable storage medium according to claim 18, further comprising an instruction that causes the programmable processor to determine instantiation of each of the plurality of common data fields for each database of the plurality of databases prior to receiving the data from the plurality of databases.
